(19) United States
(12) Patent Application Publication
(10) Pub. No.: US 2006/0149408 A1
(43) Pub. Date: Jul. 6, 2006

(54) Agent-less discovery of software components

(76) Inventors: Thomas H. Speeter, San Ramon, CA (US); Marco G. Framba, Cupertino, CA (US); David B. Duncan, Palo Alto, CA (US); Venkateshwar Talla, Picket (IN); Charles A. Bullis, Cambell, CA (US)

Correspondence Address: Sean M. Fitzgerald, 3182 Campus Drive #342, San Mateo, CA, 94402-3123, US

(21) Appl. No.: 11/206,308

(22) Filed: Aug. 16, 2005

Related U.S. Application Data
(62) Division of application No. 11/159,384, filed on Jun. 23, 2005.
Application No. 11/159,384 is a continuation-in-part of application No. 10/920,600, filed on Aug. 17, 2004.
(60) Provisional application No. 60/510,590, filed on Oct. 10, 2003.

(51) Int. Cl. G06F 19/00

(52) U.S. Cl. 700/126

(57) ABSTRACT

Discovery of software components including selecting agent-less indicators for a software component, probing one or more target computers according to the selected agent-less indicators, and receiving the results of the probe. The results of the probe are compared to a component blueprint to determine if there is one or more software components that match the results of the probe. In the event of a match, agent-less verification rules are selected and applied. The results of the application of the agent-less verification rules are compared to the expected results of the agent verification rules from the component blueprint to verify the existence of the software component.

### RELATED APPLICATIONS

The present application is a Divisional of U.S. Patent Application Ser. No. 11/159,384 entitled “Configuration Management Data Model Using Blueprints” and filed on Jun. 21^{st}, 2005, which is a Continuation-In-Part of U.S. patent application Ser. No. 10/920,600 entitled “Configuration Management Architecture” filed Aug. 17, 2004, which claims priority to U.S. Provisional Patent Application Ser. No. 60/510,590 “Configuration Management Architecture” filed Oct. 10, 2003.

### BACKGROUND

1. Field of the Invention

The field of the invention relates generally to data center automation and management systems. More particularly, the present invention relates to the field of providing application configuration information for servers in a data center.

2. Related Background

The growth of data centers has been accompanied by the growth in the complexity of software and data center operations. Many data centers have hundreds or thousands of servers, each server having at least one software application, and often many software applications, running on that server. Each of these software applications needs to be properly configured to perform according to its intended function in the installation. This configuration is complicated by the interaction between software running on other computers (either as part of the same software application or as another application). Often, changing the configuration on one server impacts software on other computers. This can restrict the possible configuration settings that may be used, and can require, or at least recommend, changes on the configuration settings of applications running on other servers. Additionally, if there are other software applications running on the same server changes to the configuration settings of one application can impact the performance of other applications on the same server.

Accordingly, an improved system of managing, tracking and implementing configuration changes is required.

### BRIEF DESCRIPTION OF THE FIGURES

FIG. 1 is a generalized block diagram illustrating an example Application Enterprise Bus, according to one embodiment of the invention.

FIG. 2 is a generalized block diagram illustrating an example organization of an Application Blueprint, according to one embodiment of the invention.

FIG. 3 is a generalized block diagram illustrating an example organization of a Component Blueprint, according to one embodiment of the invention.

FIG. 4 is a generalized block diagram illustrating an example of a computer system that may be used to implement embodiments of the present invention.

FIG. 5 is a generalized block diagram of the configuration management server shown in FIG. 4, according to one embodiment of the invention.

FIG. 6 is a generalized block diagram of server computer which may be used to implement the configuration management server or the configuration database server, according to one embodiment of the invention.

FIG. 7 is a generalized block diagram illustrating an example application blueprint, according to one embodiment of the invention.

FIG. 8 is a generalized block diagram illustrating an example component blueprint of a component of the application blueprint of FIG. 7, according to one embodiment of the invention.

FIG. 9 is a generalized block diagram illustrating additional detail of an example component blueprint as illustrated in FIG. 8, according to one embodiment of the invention.

FIG. 10 is a general flow diagram of the process of discovering software components in a data center, according to one embodiment of the invention.

FIG. 11 is a general flow diagram of the process of discovery using an agent installed on the target server, according to one embodiment of the invention.

FIG. 12 is a general flow diagram of the process of agent-less discovery of a target server, according to one embodiment of the invention.

FIG. 13 is a general flow diagram of the process of discovery of a target server using the returned probe list, according to one embodiment of the invention.

FIG. 14 is a generalized block diagram of a screen to select and run rules, according to one embodiment of the invention.

FIG. 15 is a general flow diagram of the process of applying and enforcing rules, according to one embodiment of the invention.

FIG. 16 is a generalized flow diagram illustrating the process of comparing configuration data, according to one embodiment of the invention.

FIG. 17 is a generalized flow diagram illustrating the process of comparing configuration data between applications, according to one embodiment of the invention.

FIG. 18 is a generalized flow diagram illustrating the process of comparing configuration data between hosts, according to one embodiment of the invention.

FIG. 19 is a generalized flow diagram illustrating the process of comparing configuration data between components, according to one embodiment of the invention.

FIG. 20 is a generalized block diagram illustrating the comparison of source and target blueprints, according to one embodiment of the invention.

FIG. 21 is a generalized block diagram illustrating the process of element comparison, according to one embodiment of the invention.

### SUMMARY

The present invention provides for a system and method of organizing configuration data for an IT infrastructure. A configuration data model, called here a blueprint, provides rules and/or data for discovering, verifying, interpreting and acting upon configuration data. Rules within the blueprint may specify how to resolve ambiguities, interpret configuration elements such as configuration data, establish importance weighting for configuration elements, how to make use of agents on the managed servers to discover configuration elements, how to perform agent-less discovery of configuration elements, as well as how to manage configuration elements.

The configuration management systems may perform discovery of software components including selecting agent-less indicators for a software component The seclted agent-less indicators are used to probe one or more target computers. The configuration management system receives the results of the probe, which are compared to a component blueprint to determine if there is one or more software components that match the results of the probe. In the event of a match, agent-less verification rules are selected and applied. The results of the application of the agent-less verification rules are compared to the expected results of the agent verification rules from the component blueprint to verify the existence of the software component.

### DETAILED DESCRIPTION

The present invention is described in the context of a specific embodiment. This is done to facilitate the understanding of the features and principles of the present invention and the present invention is not limited to this embodiment. In particular, the present embodiment is described in the context of a configuration management system within a data center. The present invention is applicable to configuration management on other types of computers and computer systems.

The Application Enterprise Bus (AEB) includes, in some examples, a suite of data models, tools and interfaces integrating development, quality assurance, deployment, support and operational tasks. Once exposed to the AEB, an application's structure, parameterization and operating status are visible and manageable by participants in the Application Enterprise. The AEB, for example, provides release management, configuration management, packaging and deployment tools. It facilitates applications to be structured in development, configured in the deployment phase, and moved into an operational environment. Once installed, applications can be viewed securely in their operating environment, maintained by support and development staff and troubleshot through a common view onto the system. Operations can integrate monitoring tools to the AEB, enabling them with visibility of application structure and parameterization, while at the same time exposing information from the live system to support and development.

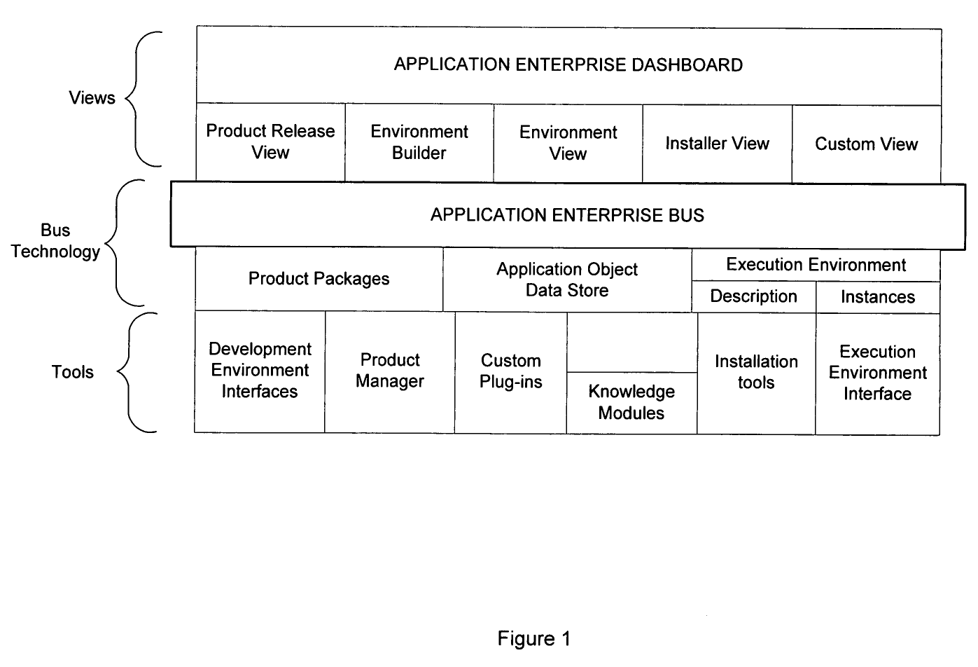

FIG. 1 illustrates an example AEB. In this example, the AEB provides a core set of technologies for organizational interfaces within the Application Enterprise; such as
Product packaging, release management and configuration
Execution environment configuration and management
Product installation, update and adaptation
Product monitoring and troubleshooting
   The technical components of the example AEB include:
Data models for versioned applications
Product definitions
Modular release packages
Configuration settings
Execution environments
Application Object Data Storage, a persistent store accessible from tools and views on the bus.
APIs for building, parameterizing, modifying, moving and installing product packages
APIs for building, modifying, inspecting and parameterizing execution environments
APIs for inspecting, monitoring and adapting live installed applications

The AEB, like a “traditional bus” operates according to standard interfaces for modular system components. In this case, the system whose interfaces are to be standardized is the Application Enterprise (including development, deployment and operations tasks). The AEB integrates tools and data representations used by IT, support departments, operations and development organizations. Additionally, the bus allows tools to be introduced to bridge the gaps between organizations, providing a unified toolkit and view of application components.

The AEB defines a set of objects, each with its own data model. These objects can be created, viewed and manipulated by tools connected to the AEB. These objects include; for example:
Components (individual software modules, such as a web server or database)
Applications (versioned, configurable models of services composed of multiple host types and components)
Host Groups (target environments for the deployment of an application)
Deployments (executing instances of an application on a particular Host Group)

Development organizations maintain strict control over source code, data and known system bugs. It is less common during the development phase to directly consider deployment and operational issues. The AEB, through its interfaces to the development environment, provides the ability to address these issues up front. Deployment and operational factors impacting or caused by the development organization include; for example:
Lack of accurate, timely documentation on application configuration parameters (environment variables, caveats, runtime parameters, tables of data)
Ad-hoc syntax used to define application configuration parameters
Nonstandard management of configuration parameters in a version control system, or storage of configuration parameters outside of the change control process altogether.
Release notes that do not identify application components associated with known issues.
Inability to quickly and accurately create operational execution environments across development, QA, staging and production. This includes network, software and data configurations.
Custom, poorly documented release management tools and processes.
Troubleshooting scripts and debugging insight gathered by the developers (because of deep application knowledge) not exposed to support and operations staff.

To address these issues, the AEB facilitates developers to structure and expose application configuration, scripts, and release notes to the application bus. Developers can identify application assets as they are defined during the development phase. Via integration with the IDE, or through a developer's use of the Product Release View, elements in or outside of the source control system can be identified as deployment assets. After identification, these assets are visible as part of the application object and can be viewed and managed through the on dashboard AEB. Views (i.e. visibility) and actions are available whether the object remains in development, is packaged and about to be deployed, or is deployed and in operation.

Release Management

Applications are typically an assembly of built products (libraries and executables), content, configuration parameters, scripts, policies, third party applications, documentation and supporting files. Product organizations generally have one or more “build-meisters” who are responsible to schedule builds, manage build products and package the build products as applications for delivery to operational environments. Packages are versioned and correlated with labels or branches in the source control system and bug reports are correlated with the released package. The Product Manager tool is used to organize the packaging, versioning and correlation of application components. It saves the build-meister from writing custom tools for this purpose, as happens in most development organizations. The Product Manager is a bridge from the AEB to the build, bug tracking, and source control systems. The Product Manager is compatible with common source control applications (ClearCase, CVS, SourceSafe) bug tracking; build technologies, and packaging tools. The Product Manager gathers targets from the build environment, packaging them into an application object that is connectable to the AEB. The Product Manager's packaging is compatible with existing package formats (tar, jar, RPM, Install Shield, CAB, cpio).

The Product Manager is flexible such that it can be connected at whatever level the organization desires or requires. A simple linkage can be set up at first, for example, wrapping existing packages with the Product Manager then using the AEB to move and manage the package to operations. With time, more functions can be migrated to the Product Manager, making more elements of the application visible to the AEB. Flexibility of the interface and the ability to evolve integration of release processes to the AEB are desirable features of the Product Manager.

Propagation Policies

Applications are characterized by policies that define a way to move them between build and execution environments (development, QA, staging, operations). Policies, such as check-offs from one group to another, tracking of issues and documentation of application status can be organized and managed through the Product Manager. When products are ready for deployment (using the Installer, see below), policies are enforced and movement activities are tracked and can be audited.

A deployed application is a packaged product, configured and deployed to an execution environment. The target host group may include, for example, various types of servers, network elements, storage, data and supporting software components. Structured deployment of a package to a target environment uses an environment model, and typically assumes that the incoming package is sized and parameterized for that environment. The interface between development and operations with respect to product deployment is typically unique for each product, worked out between the groups according to each one's capabilities. Sometimes complete system images are delivered to operations; sometimes only data, content and a few executables are delivered, and IT or operations sets up system components (hardware and/or software) to support the product. In most cases, a deployment team adds parameterization to the product as it is moved into production, to specifically configure it for the target execution environment.

The ability to define an execution environment and to inspect the implementation of the definition (for example to verify it) is provided by the Execution Environment Builder. Using a common view through the Application Enterprise Dashboard, development, support and operations staff can see and understand the target environment and visualize how an application package maps onto it. Parameterization can move in both directions, facilitating developers to define and document configurations to operations and support, while enabling the export of operational configurations to development and support environments. This addresses a fundamental set of issues that arise between development, support and operations; such as:
Inability to clearly define what an environment includes.
Inability to setup and duplicate environments from one machine/set of machines to another.
Inability to quickly verify that an environment is configured according to its specification.
Inability to answer the question. . . ‘what changed in the environment?’.

Component Blueprints are supplied for the construction of execution environments, allowing drag-drop style definition of target systems, Component Blueprints provide built in knowledge of component structure, installed footprint, dependencies, and parameterization for system setup and tuning. Component Blueprints are defined for all layers, from hardware, networking, firewalls, to load-balancers, operating systems (NT, Win2000, Unix), application platforms (Net, J2EE, ) , web-servers (US, Apache, iplanet), databases (Oracle, SQL Server, DB2) and application suites (SAP, PeopleSoft, Siebel). Once defined, application components and configuration parameters can be viewed, queried and modified through the Application Enterprise Dashboard.

Installation Tools

The Installer moves application packages and their parameterization and updates from the development or deployment environment to an operations environment. Often a firewall is in place between these organizations to prevent un-audited modification of executing software, or to prevent non-operations staff from accessing data in the operations environment. The Installer provides secure, audited movement of packages to operations and ensures proper deployment of products to selected machines.

Many issues associated with application configuration and-installation are addressed by the Installer.
Exposition of configuration parameters and application structure to the deployment team. Access is through a common view available to development, deployment and operations staff.
Explicit visibility and management of data, scripts and configuration files as part of the installation process.
Provides auditable, secure movement of application packages and data to the target environment.
Allows the definition of an installation workflow, including an order of actions, running of scripts, and check-pointing along the way.
Allows installation ‘dry-runs’ for testing application deployment without actually installing components to the target environment.
Provides a verifiable inventory of all installed components.
Provides transactional install, update and adaptation capabilities.
Provides structured ‘bring-up’ of application components.
Tracks the update and adaptation of an application once it is installed.
Makes the installed application and its operational environment visible and manageable, through the AEB.

The Installer in conjunction with the Release Manager implements transactional installation/deinstallation, roll-in/roll-out of patches and tuning of parameters in such a way that changes are recognized and automatically organized into deployment patches

Releases are application versions managed by the Release Manager. One step in the workflow of application installation is the check-off that exposes a version as a Release. This function is reversible, allowing a release to be decommissioned when it is obsolete, or withdrawn as an installation candidate if problems are discovered.

Once checked off, the Installer is employed to install a Release to one or more execution environments. The installation process combines a Product application object with an Environment object to map the virtual application to a specific target. At this time, configuration parameters identified by development are visible to the deployment team through the Installation View. Data, environment variables, runtime parameters and other configuration can be populated and verified. Once the configuration has been specified and verified, installation can take place. This involves securely moving application components to their targets, placing components where they belong and verifying that all of the parts are accounted for and are in place. Installation may include the placement of application products on a configured server, or complete imaging of the servers with applications components included. The Installer operates in either mode. Installation workflows can be defined, ordering the installation of components, running scripts, and prompting for feedback during the process. Because installations are transactional, they can be aborted and rolled back at any point in the workflow.

After component installation, a common problem is inability to ‘bring the system up’. This may be due to application misconfiguration, missing components, bad data, hardware/network failure, software version incompatibilities or other problems. The Installer and Development Interfaces can help to structure an application so that misconfiguration and missing components are minimized or eliminated. But beyond application structuring, the Installer allows OS independent application bring-up to be scripted, and made visible to the AEB. The Installer handles security and OS specific tasks on installation, allowing the application to be activated and deactivated from the Installer View. The Activation step is often overlooked until an application is first deployed and it becomes the operations team's task to script system bring up and debug problems as they occur. By explicitly defining Activation as an application component and by providing tools to structure and automate the process, the AEB fills a critical gap.

Updating installed systems and tuning application parameters are common, although not always well structured, tasks in the Application Enterprise. Through product definition with the Release Manager, partial updates are applied to installed system, using similar (if not the same) process and interfaces as installation. The Installer optimizes updates by installing only those components that have changed, speeding the deployment of patches, thus minimizing downtime for updates.

The tuning of installed applications is called adaptation. Many parts of an application are tunable, including parameters from hardware, OS, application and network levels. Both the Installer View and Environment View facilitate enabled users to view and modify parameters that have been exposed to the AEB. All changes are recorded for auditability, and may be rolled back if needed. This capability addresses two fundamental issues in the Application Enterprise. First, explicit definition of tunable parameters helps to document the variables that control application behavior. Second, auditable control over adaptation keeps undocumented changed from creeping into the system, giving operators confidence to allow support and development staff access to the system for troubleshooting.

Data Model of an Application-Abstract Blueprint.

(a) Layered, with nesting.

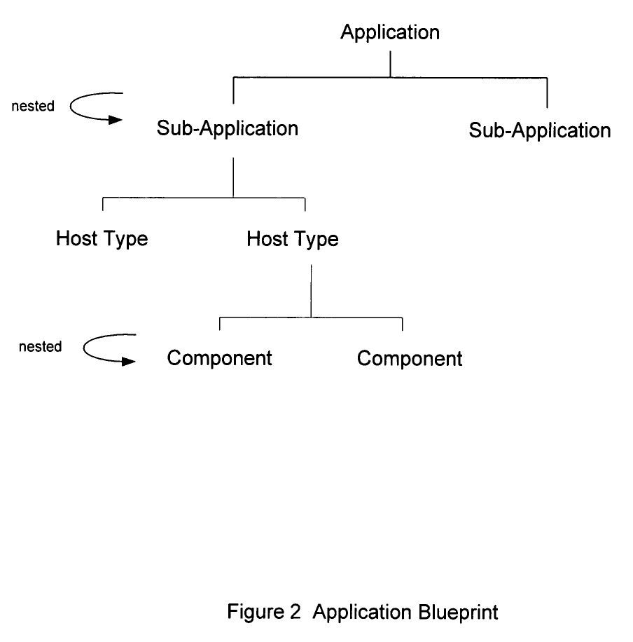

FIG. 2 illustrates an example organization of an Application Blueprint.

The Application Blueprint describes the generic structure of a software application. It is an abstract model that is not specific to a particular deployed instance. The application may at first be decomposed into (potentially nested) sub-applications. Sub-applications are independent units within the larger application structure, that may be separately maintained or released within the Application Enterprise. For example a billing system or streaming video capability may be considered a sub-application within a larger customer facing service. Within the sub-application (or the application, if no sub applications exist), specific host types are identified. Distributed applications typically have different types of computational servers performing specialized ftunctions such as serving web pages or acting as a database server. Each host type has a set of associated components, potentially nested.

The application blueprint data model represents the structure shown in FIG. 2, in addition to rules defining whether elements in the model are required, have dependencies on one another, and have version dependencies or other rules constraining the eventually deployed image of the application.

Component Blueprint

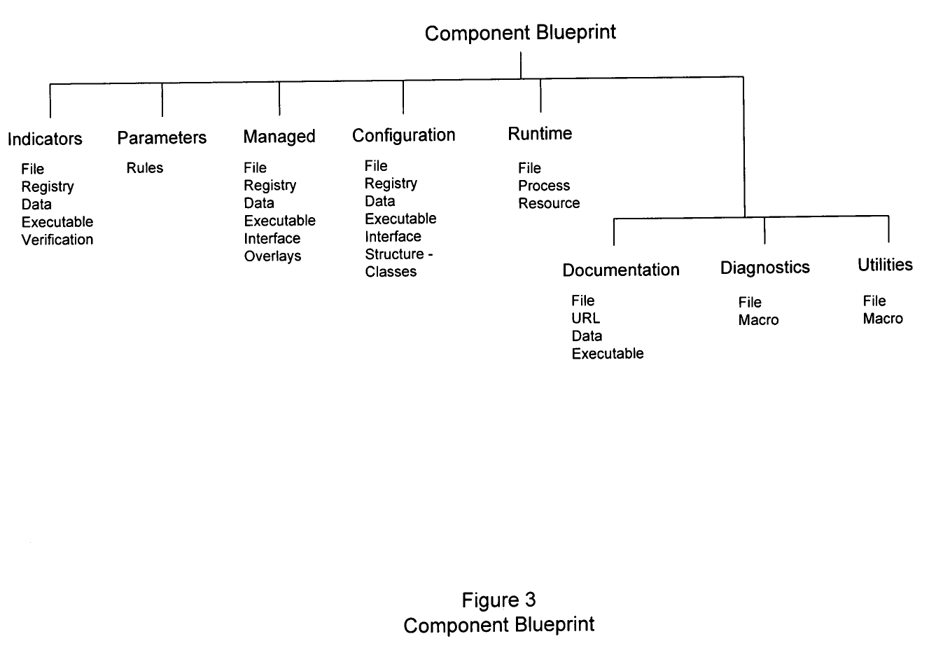

The component blueprint, an example of which is illustrated in FIG. 3, provides a data model for an individual software component. Indicators provide rules, based on the presence, location and relative values of files, registry variables, data, or executable output, for how to locate an installed instance of the software module. Verification rules allow the discovery to be verified if there may be ambiguity. Parameters are rules for the calculation of important values, such as the location where the component is installed, or its version.

The Managed container holds rules for determining the ‘parts-list’ of the component, identifying all of the pieces belonging to the component, including files, data, registry values, directory server sub-trees or other resources available through interfaces. Overlays can be provided that define rules, annotation and categorization of individual managed elements.

The Configuration container enumerates and defines all of the configuration ‘knobs’ for the component. Structure classes can be provided that define how to parse configuration information, rules, annotation and interpretive information for each configuration element.

The Runtime container identifies the components runtime signature, including processes, log files and other resources uses or modified while the component is running.

The Documentation container collects documentation from the component vendor into one location. This includes files from within the managed files container, web pages, data and the output of executables.

The Diagnostics and Utilities containers organize executables that can be used to respectively administer or troubleshoot the component. Executables and scripts are exposed, along with common parameterizations as Diagnostics/Utility files. Sequences of actions and conditional logic can be chained together as Macros, allowing typically sequential activities to be gathered together and executed as a unit.

All elements specified are collected by the blueprint can be categorized and weighted. Categorization facilitates any number of descriptors such as “Security” or “Performance” to be associated with an element. These act as attributes that can be queried for during operations executed against a discovered component. Weights allow the importance of elements in the blueprint to be identified. This allows operations on discovered components to be tuned so that only the most relevant elements are considered.

All software components are defined using the same component blueprint data model. This normalization process facilitates all components to be stored and viewed similarly. Users not familiar with a given component are able to find and work with information in the model because of this normalization.

2. Discovery

Discovery is the process of locating installed components and applications on a set of hosts. The mechanism of discovery is to, in parallel, query an agent software process running on each host that is to be interrogated. The agent process looks for the indicators defined in the component blueprints and reports the results back to a centralized server. At the centralized server, results from all of the agents are correlated into a complete image of the deployment. The results of discovery are stored in a database from which they can be retrieved, viewed and updated.

(i) One form of discovery uses an Application Blueprint to guide the discovery process. The Application Blueprint defines a set of components for which search. Each Component Blueprint defines how the corresponding component is to be located and verified. Once components are verified, host types and sub applications are identified according to the rules in the Application Blueprint. When discovered, the deployed application is called a ‘Deployment’. Rules within the Application Blueprint can be used to discard components that violate the Application Blueprint. For example, components that are at a certain location in the file system will be discarded if they are not found at that location.

(ii) A second form of discovery does not use an Application Blueprint. Instead, a set of components is chosen, without identifying host type, or sub application information. The components are located in the same manner as (i), but when completed, the discovery process automatically builds an Application Blueprint from the list of discovered components. The generated Application Blueprint can be augmented with rules and additional structure so that it can be subsequently used for type (i) discoveries.

3. Operations

(a) Refresh

After a deployment has been discovered, elements among the managed components may change. For example files may be moved or configuration parameters may be updated. To get a current image of the deployment, and to update the stored deployment image in the database, the deployment may be refreshed. During refresh, agents on each managed host are asked to review all of the managed components, and report differences to the server. The time stamped, updated deployment image is stored in place of the previous deployment image.

(b) Snapshot

To retain an image of a discovered deployment, so that refresh operations do not cause historical information to be lost, a snapshot can be taken. A snapshot causes a duplicate copy of the deployment image to be created in a database. This image is marked as a snapshot and subsequently cannot be modified, since it is a historical record that should remain unchanged from the time that the snapshot is taken.

(c) Compare

Comparison can be used to determine if a deployment is drifting away from a standardized configuration (a gold-standard or template), or it can be used to investigate the difference between different deployments, or the same deployment across time.

(i) Comparisons of deployment images can be made across time and across space. A deployment image can be compared against a historical snapshot of the same deployment, or two snapshots of the same deployment can be compared. These are considered to be “across time” since they are images of the same thing, only at different points in time. Alternatively, two entirely different deployments can be compared against one another. For example, an image or snapshot taken from a staging environment can be compared to an image or snapshot taken from a production environment. These are considered “across space” since they are images of deployment on different hosts, located in different places.

(ii) Comparisons can be made at multiple levels in the application blueprint hierarchy. Comparison can be deployment/snapshot to deployment/snapshot, or can be sub-application to sub-application, host to host, or module to module, for example. Comparisons that are host to host or module to module can either be one-to-one, or one-to-many. For example, one host can be compared against one other host. In the one to many case, for example, one module on one host can be compared to many other modules on the same or other hosts. Comparisons made at different levels can either be across time or across space, and may be within a single deployment or across different deployments.

(iii) An important factor to consider when making comparisons is the comparison signal-to-noise ratio (SNR). The SNR is a measure of how many relevant differences are discovered divided by the number of total differences (relevant+irrelevant) that are reported. A relevant difference is one that has important consequences or is of interest to member of the application enterprise for ongoing operational or support reasons. For example, to report that a log file changes size is not important, since it is expected and normally unimportant. But if a key executable file is missing, that is important. The higher the SNR the more useful the comparison. The ideal value is ‘1’. To raise the SNR, the number of irrelevant differences should be lowered. To partially accomplish this, the categorizations and weighting defined in the Component Blueprints are used. The user can limit the number of irrelevant differences detected by narrowing the scope of the difference operations. By choosing weights and categories to consider, or by excluding certain weights and categories from consideration the user can tune the operation so that fewer irrelevant differences are reported. In addition, the system automatically applies filters based on the type of comparison selected. If comparison across time is selected, then elements that are expected to vary with time are not compared. Examples of these include log file sizes and usage counters. If comparison across space is selected then items that are expected to vary between different deployments are ignored. Examples of these include file creation and modification time stamps and parameters whose values are host names.

(d) Verification

Verification is the process of running rules that have been defined on the elements of a deployment image or snapshot. Rules are Boolean expressions involving the value of one or more elements, or the values of element attributes. All elements in a deployment have a value (for example the value of a registry key is its defined value), and some elements have attributes, which are name-value pairs (for example a managed file has an attribute called size, which is the number of bytes in the file).

Rules are used to define a set of constraints on the deployment image. They can limit an element's value or an attribute value, or constrain one value relative to another. All rules return a Boolean result, true or false. Rules are assigned a severity, allowing selection at verification time of the severity level or rules to run.

Rules can be defined in the component blueprint, or a rule can be defined directly on the deployment. If defined on the blueprint, the rule is attached to each component instance within the deployment when it is discovered. Many rules are automatically generated, and these are called implicit rules. Implicit rules are created from data type restrictions and default value specification. When an element has it's data type defined in a component blueprint, a rule is generated that will fail if the value of that element does not conform to the data type. If an element has a default value (a value that the system will use if no other value is defined, for example in a configuration file), then an implicit default value rule will be generated.

When verification is executed, a severity level is chosen, and the set of rules to execute is defined. One constraint on the set of rules to run is the rule type. Rule types include Component Blueprint rules, Deployment rules, and default value Rules.

(e) Export/Import

In addition to a common data model, a portable representation of the model and its contents is defined. The portable format allows deployment images to be exported from one data store, and imported to another. An exported blueprint, deployment or snapshot image is represented in a single file that can be encrypted and easily be moved from one location to another. This allows comparison and verification to take place away from the actual physical location of the deployment. Software vendors, for example can utilize this capability to take exported images of customer installations and import them within their support organizations to help troubleshoot problems. The export format can also be used for archiving since it is a space efficient representation of the deployment image.

(f) Communication

The deployment image can be used as a communication tool that binds together members of the Application Enterprise. Links into the image can be embedded into conventional communication tools, like e-mail so that co-workers can communicate effectively about the exact location of issues within the deployment image. Notes and rules can be attached to the application and component blueprints, or do deployment images allowing members to annotate the application with information at precise locations within the data model.

Organizations outside of development and operations (for example finance, marketing or sales) may require visibility to portions of the Application Enterprise, Even customers may want access so that they can verify application parameters, verify system functions and ‘feel comfortable’ that their applications are running and are well managed. Via a secured Custom View, guests, customers and/or other users can be granted access to any or all products and execution environments plugged into the Application Enterprise Bus. This is a powerful extension, allowing controlled and auditable access to what is conventionally a closed environment. Access control can be configured so that only selected objects are visible and selected operations are enabled.

A common view shared by all associated organizations and customers helps to expedite troubleshooting during periods of application instability, helps all parties to plan future releases and strategies, and provides a common vocabulary and understanding of how the application runs and how it is developed and released.

From both the development and operations environments, the open interfaces of Application Enterprise Bus allow integration of all parts of an Application Enterprise into a common view. Project management, Schema and OO design tools can be plugged into the bus via standard interfaces. Schema design, for example can be used to provide operations staff and database administrators a sophisticated view of database, triggers, stored procedures and constraints that they would otherwise not be afforded. Alternatively, operational tools (e.g. HP OpenView, IBM Tivioli, CA Unicenter) can be integrated into the bus, providing developers a view onto the running system. Because these custom tools are accessed through the Application Enterprise Bus, the applications associated with each capability do not have to be installed (saving license costs).

4. Security

(a) access control to the schema

Access control is configurable to restrict views and/or application objects across the AEB user base. Well-managed security implementations require that policy be coherent and fully documented by a team of security experts. While it is often the case that policies are documented, it is rarely true that implementation of the policy can be accurately or conveniently tracked. The Product Manager allows security policies and associated parameterizations to be defined, viewed and managed from a single interface. This provides a powerful capability to centralize security policy, allowing only those individuals responsible for and knowledgeable of the policies to control their implementation. The security policy of an application can be audited from a single place and those responsible for security within an organization can be assured that the policy is defined and implemented correctly

(b) access control to application object

Users within the Application Enterprise have different needs and restrictions as they view and act on deployment images. Users can be restricted to read, write, or execute access on any object or function within the deployment image. Access can also be controlled to the meta-data, for example the building and modification of application and component blueprints.

(c) integrate with existing security—e.g., directory services

Users within the Application Enterprise can be configured and given permissions by an administrator as they are imported from the organization's enterprise directory (e.g. LDAP).

5. Transactional Operations

Because the application enterprise bus federates the Application Enterprise, operations can be transactionally performed across the enterprise in way not previously possible. Transactional operations are actions on the deployment or deployment image that conform to the well-known ACID properties of transactions. That is, they are (a) Atomic, all parts of the operation happen, or all do not, (b) Consistent, the target of a transaction remains in a consistent state before and after the transaction, (c) Isolation, the transaction is isolated from other activity or other transactions in the system and (d) Durable, once completed and committed, the changed caused by the transaction are permanent. An important feature of transactions is ‘rollback’, allowing changes to be removed before they are committed to the system.

Transactions across the deployment are enabled by federations and aided by the underlying data model. The transactional operations enabled include

(A) Replication: using the results of a compare operation, deployments, hosts and components, or any element within a component can be made identical, across time and space. Differences detected during comparison are transactionally made the same. All differences are made with ACID properties, and can be rolled back if not appropriate.

(B) Repair: using the results of a verify operation, deployment, host, or component structure, or element values and attributes values can be made compliant to rules in a single transactional operation.

(C) Installation, update, tuning: Installation of entire applications, using the application blueprint as a guide can be transactionally performed across any group of hosts in the Application Enterprise. Update of installed applications, including file, data, registry, configuration or other element changes can be transactionally executed using a patch blueprint, defining the elements to be changed, sequencing and rollback information. Tuning involves minor change to configuration, and is like update, but limited to configuration parameters.

### CONFIGURATION MANAGEMENT SERVER

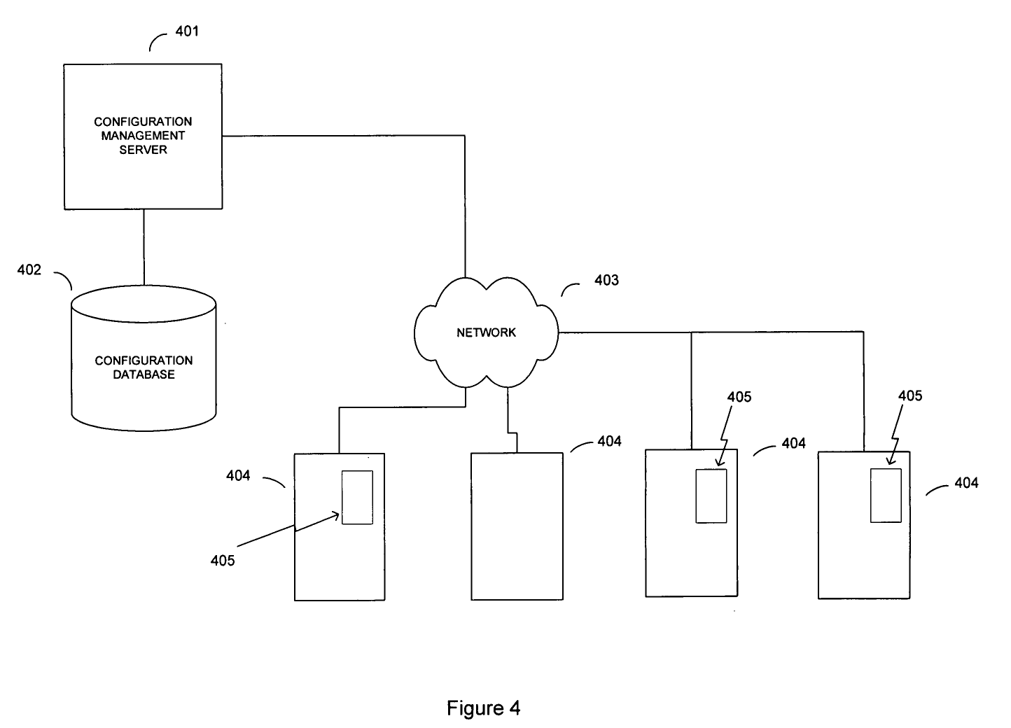

FIG. 4 is a block diagram of a computer system 400 that may be used to implement embodiments of the present invention. A configuration management server 401 is connected to a configuration database 402. The configuration server is connected to a communications network 403, which is connected to a plurality of servers 404. While the present invention will be described in the context of application servers or web servers, other examples of the servers 404 include database servers, storage area network (SAN) systems or storage devices, network devices such as routers or switches, personal computers or workstations, or any other type of electronic device which can interoperate with an information technology system.

In the presently preferred embodiment, the application servers have configuration agents 405 installed. As shown, applications servers need not have a configuration agent installed to allow the configuration server to manage the configuration of the application server.

The configuration management server provides access to the data of the configuration database, presents reports, performs or orchestrates discovery, performs comparison between a source and target server, implements rules and determines relationships between configuration items.

The configuration management server and the configuration database server could be implemented on one single server or on multiple servers. As used in the present application, the term server may refer to a physical computer or to software performing the functions of a server.

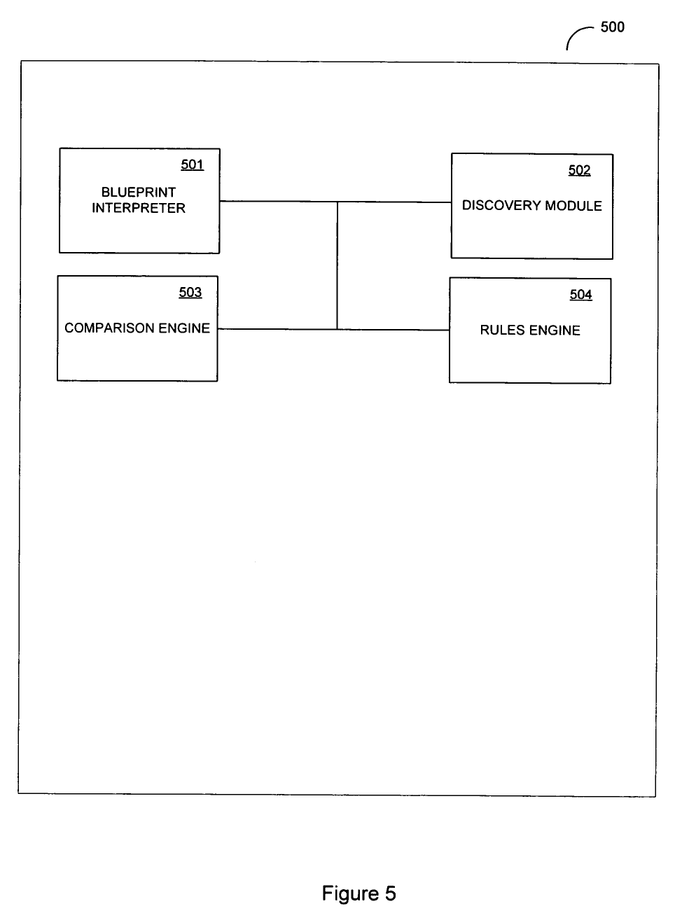

FIG. 5 is a generalized block diagram of the configuration management server shown in FIG. 4. The configuration management server includes a blueprint interpretation module 501 which parses blueprints to recover information and rules contained in the blueprint. The blueprint module interprets both application blueprints and component blueprints.

The configuration management server also includes a discovery module 502 which controls the process of discovering applications, hosts and components described below. A comparison engine 503 allows the configuration management server to compare the known attributes of two servers across time or space, as described below.

A rules engine 504 interprets and applies rules against the known attributes of the servers contained in the configuration database. The rules engine may be used to derive relationships between different configuration elements, and by extension, different computers, software components, or data.

While the presently preferred embodiment utilizes the configuration database as a separate database from the configuration management server, alternate embodiments could utilize one server for both the configuration management server and the configuration database. Additionally, the information stored within any single database of the presently preferred embodiment could be distributed among several databases in alternative embodiments.

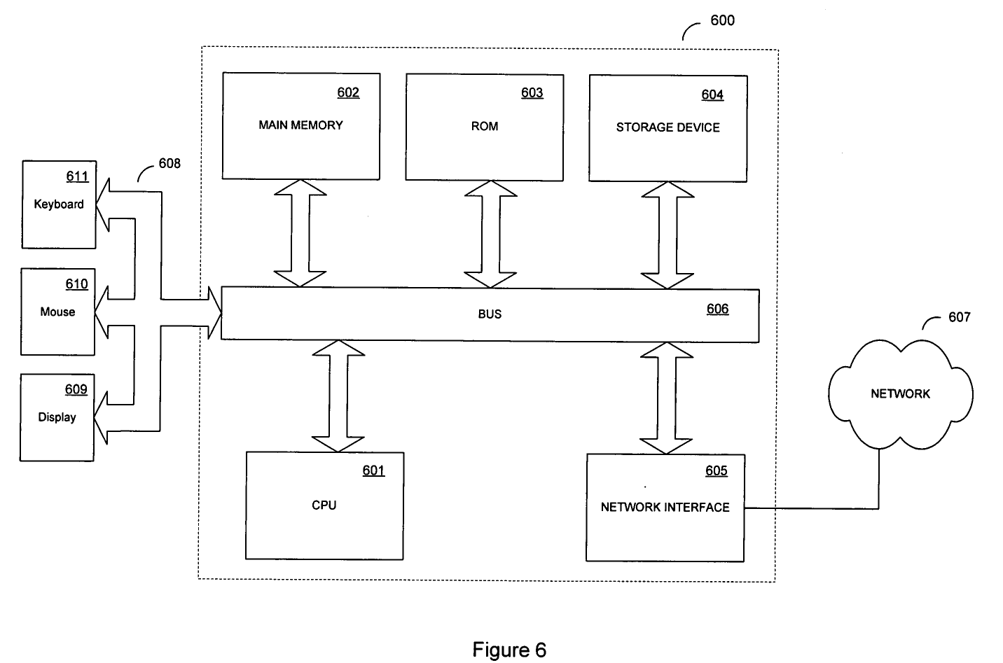

FIG. 6 is a generalized block diagram of server computer 600 which may be used to implement the configuration management server or the configuration database server described above. The server computer 600 includes a central processing unit (CPU) 601, main memory (typically RAM) 602, read-only memory (ROM) 603, a storage device (typically a hard drive) 604, and a network device (typically a network interface card, a.k.a. NIC) 605. The network device connects to a communications network 607. The server includes a bus 606 or other communication mechanism for communicating information between the CPU 601 coupled with bus 606. The CPU 601 is used for processing instructions and data. The main memory 602, ROM 603 and storage device 604 are coupled to bus 606 and store information and instructions to be executed by processor 601. Main memory 602 also may be used for storing temporary variables or other intermediate information during execution of instructions to be executed by processor 601.

Server 600 may be coupled via bus 608 to a display 609, such as a cathode ray tube (CRT) or flat panel monitor, for displaying information to a computer user. An input device 310, such as a keyboard, is coupled to bus 608 for entering information and instructions to the server 600. Additionally, a user input device 311 such as a mouse, a trackball, or cursor direction keys for communicating direction information and command selections to the processor 601 and for controlling cursor movement on the display 609 may be used with the server 600.

The server 600 is designed to run programs implementing methods, such as the methods of the present invention. Typically such programs are stored on the hard drive of the server, and instructions and data of the program are loaded into the RAM during operation of the program. Alternate embodiments of the present invention could have the program loaded into ROM memory, loaded exclusively into RAM memory, or could be hard wired as part of the design of the server. Accordingly, programs implementing the methods of the present invention could be stored on any computer readable medium coupled to the server. The present invention is not limited to any specific combination of hardware circuitry and software, and embodiments of the present invention may be implemented on many different combinations of hardware and software.

As used within the present application, the term “computer-readable medium” refers to any medium that participates in providing instructions t CPU 601 for execution. Such a medium may take many forms including, but not limited to, non-volatile media, volatile media, and transmission media. Examples of non-volatile media include, for example, optical or magnetic disks, such as storage device 604. Examples of volatile media include dynamic memory, such as main memory 602. Additional examples of computer-readable media include, for example, floppy disks, hard drive disks, magnetic tape, or any other magnetic medium, a CD-ROM, any other optical medium, punchcards or any other physical medium with patterns of holes, a RAM, a PROM, and EPROM, a FLASH-EPROM, any other memory chip, stick or cartridge, a carrier wave as described hereinafter, or any other medium from which a computer can read. Transmission media includes coaxial cables, copper wire and fiber optics, including the wires that comprise bus 606 and 608. Transmission media can also take the form of acoustic, electromagnetic or light waves, such as those generated during radio-wave and infra-red data communications.

The content server and end user communication device are similar in general architecture to the access analytics server.

### CONFIGURATION DATA MODEL

The present invention provides a method of organizing configuration information of software and the servers the software runs on, as well as other software and devices the software and server interact with, to provide the ability to manage, track changes, analyze, enforce policies and optimize the IT infrastructure. This configuration information is organized in a data model to allow visibility of configuration settings in an IT infrastructure.

The configuration settings of computers, devices, and software are organized in a configuration data model. The configuration data model include blueprints which provide structure to the configuration settings (or configuration parameters). The structure provided by the blueprint provides information on the use and relationships of the configuration parameters. This information may be leveraged by the present invention, or by systems which integrate with the present invention, to provide greater context to the actual configuration settings, as well as aid in the discovery, retrieval and interpretation of configuration elements.

As described above, application blueprints are generalized abstractions of a software application, which may be organized into several levels. This modeling reflects the complexity of software applications, and in particular enterprise class software applications installed and running in corporate and government data centers. While an application blueprint is conveniently envisioned as relating to a particular software application or component, for example Oracle's™ Financials or BEA's Weblogic™, an application blueprint may include any assembly of software, whether from a single software vendor or from multiple software vendors, and may even include non-commercial, or custom software, as well as open-source software (for example, the Apache web server). Application blueprints may include software installed on multiple physical computers (or hosts). Software applications on multiple hosts are referred to as “distributed” applications.

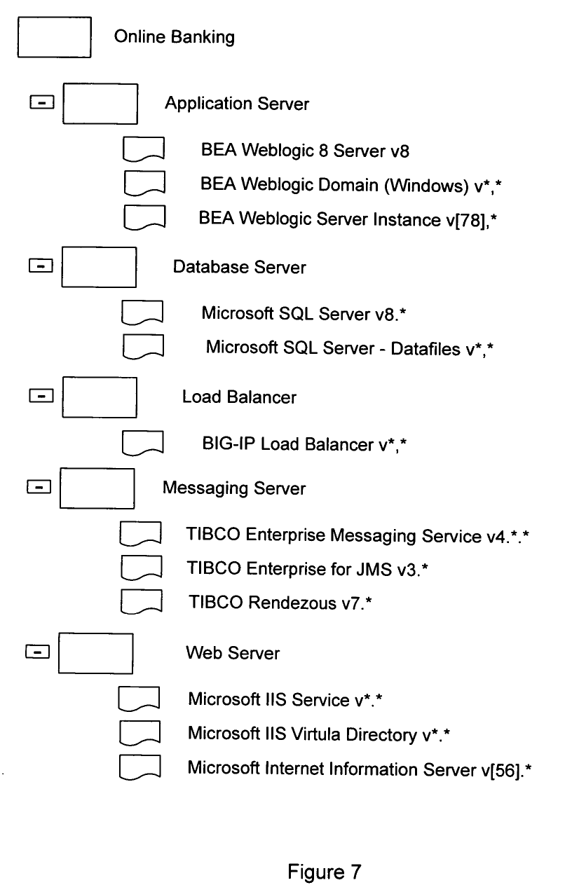

FIG. 7 is a generalized block diagram illustrating an application blueprint. As shown in FIG. 2, the application blueprint includes multiple levels for sub-applications, host types, and components. Referring now to FIG. 7, an example embodiment of an application blueprint 700 is shown which identifies, at the highest tier, Online Banking. The next tier below Online Banking identifies five host type components. Specifically, the host type components of this example include Application Server, Database Server, Load Balancer, Messaging Server and Web Server. The next tier below the host type tier specifies the software components which implement the host type. As shown in the example, the host type Application Server is implemented by three software components, which are: BEA Weblogic 8 Server v8, BEA Weblogic Domain (Windows) and BEA Weblogic Server Instance. Not shown in FIG. 7 is a dialog box (or other form of displaying) which illustrates the details of the Component Blueprints, which include the name of the software component, the version of the software component, the blueprint version of the version of the named software component, and a description of the named software component.

As this example shows, the Application Blueprint may include more than a single commercial software component, and may be organized to include multiple components. Furthermore, the application blueprint may be organized to include the various components which, collectively, provide a service or function which is of importance, either to the people managing the datacenter, or two those who interact with or rely on the service or function.

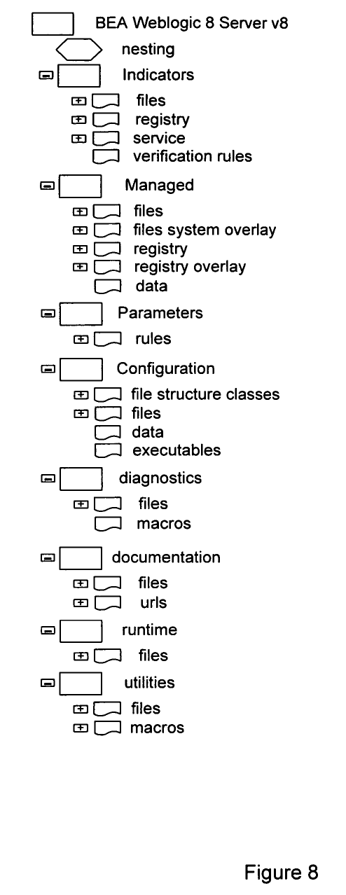

Additional information on the software components is given in the example of a Component Blueprint shown in FIG. 8. The Component Blueprint 800 is of the BEA Weblogic 8 Server v8 component of the Online Banking Application Blueprint 700 shown in FIG. 7.

The component blueprint is a data model for organizing the known attributes of a given component. The blueprint provides a set of rules for structuring the known attributes. Examples of rules include nesting rules which provides rules for how a given component nests within other components when displayed.

Additional rules contained within the component blueprint are the “indicators” which provide rules for discovering the component using the discovery process described below. Indicator rules act like “fingerprints” that identify the existence of a component. Example indicator rules include: File which includes rules defining the files/directories, and their relative locations that conclusively indicate the presence of the component. Another example rule set within Indicators include Registry rules which define the registry keys/values, and their relative locations that conclusively indicate the presence of the component. More than one set of rules is allowed. If more that one set is defined, they are treated as statements in an ‘or’ conditional expression. Additional indicator rules may include Service rules which define the agent-less signature of a component. These service rules may include rules that provide definitions of TCP/UDP ports to scan and probe/response tests to determine the existence of components from outside of the server. Also within the indicator rule sets may be Validation Rules which are used to test whether components discovered with the indicators are of the correct type and version. One example validation test is to check that the version of a component is consistent with the version of the component blueprints (in the case where there are different component blueprints for different versions of the component).

Additional rules which may be contained within the component blueprint are the “Managed” rules which determine configuration elements that belong to a component. The rule sets within Managed may include Files, File System Overlay, Registry, Registry Overlay and Data. The Files rules define the set of files that belong to (and don't belong to) the component. The File System Overlay rules provide a tree structure that is over-laid on top of the components managed files. The overlay applies attributes and interpretation to the files defined in the managed section. The interpretation may include description, categorization (such as security, network, performance . . . ), the weight (relative importance), comparison filters (for example time variant, host specific, etc.), hot links to documentation/information about the file, file attribute constraints (for example file size, ownership, permissions, existence, version, etc.

The Registry rules define the set of files that belong to (and don't belong to) the component. Registry Overlay rules provide a tree structure that is overlaid on top of the components managed registry tree. The overlay applies interpretation to the keys/values defined in the managed registry sections. The interpretation may include a description, categorization (such as security, network, performance, etc), a weights, comparison filters, hot links to documentation about the registry variable, a default value, semantic interpretation (such as host name, IP address, email address, etc.), and relationship key (whether the key/value defines an external dependency).

The Data rules define databases and tables within those databases to manage and may include rules specifying the location, type and access information for a particular database. Additionally, Data rules may specify the schema and/or table names. In the presently preferred embodiment, for each table specified, the data definition of that table is managed (for example column data types and indices).

Additional rules contained within the component blueprint are the “Parameters” rule set which provide rules for a set of named values that provide contextual significance in understanding the installed configuration of the component. Typical parameters may include the component version, installation root, vendor name and product name. With the Parameters rules may define how the value of a parameter should be determined. For example the value of ‘Version’ may be determined by executing a binary installed by the component and filtering the output with a regular expression.

Additional rules contained within the component blueprint are the “Configuration” rules. The Configuration rule set may include rules specifying Structure Class Overlays for the configuration items managed in configuration files, data or executables. The interpretation of configuration items may includes: description, categorization (such as security, network, performance, etc.), weight, comparison filters (for example, time variant, host specific, etc.), hot links to documentation/information about the item, a default value, data type, semantic interpretation (which may include host name, IP address, email address, etc.), relationship key (which may specify whether the key/value defines an external dependency). Additionally, the Configuration rule set may also include rules constraining the value of a configuration item. Virtually any type of value or pattern constrain may be defined through a constraining rule. The Configuration rule set may also include rules identifying a list of files containing configuration data from among the managed files for the component, and identification of the structure class used to interpret the configuration. The Configuration rule set may also include rules identifying a set of queries retrieving configuration data from one or more of the managed databases, and identification of the structure class used to interpret the configuration. The Configuration rule set may also include rules identifying a executables and the returned value or function of the executable, thus identifying data collected from a source (output of executables, SNMP, LDAP, JMI, WMI etc.), and an identification of the structure class used to interpret the configuration.

A Diagnostics folder may contain executable files and parameters that are used to diagnose problems (including runtime problems) with the component. The Diagnostics folder may include Diagnostic Macros, i.e. named sequences of commands and operations used to diagnose problems with the component.

Additional rules contained within the component blueprint are the “Documentation” rules set. This set may include rules on files that are among the managed files for the component, that contain documentation about the component, and may also contain URLs (normally to the vendor web site) documenting the component.

Additional rules contained within the component blueprint are the “Runtime” rules set. This set may include rules on files that are among the managed files for the component, that may contain time variant data. Examples of runtime files include, without limitation, log files, and process ID files.

A Utilities folder of the component blueprint may contain maintenance and administrative scripts and procedures. Included within the Utilities folder may be executable files and parameters that are used to maintain and administer the component, as well as Utilities Macros which may specify named sequences of commands and operations used to maintain and administer the component.

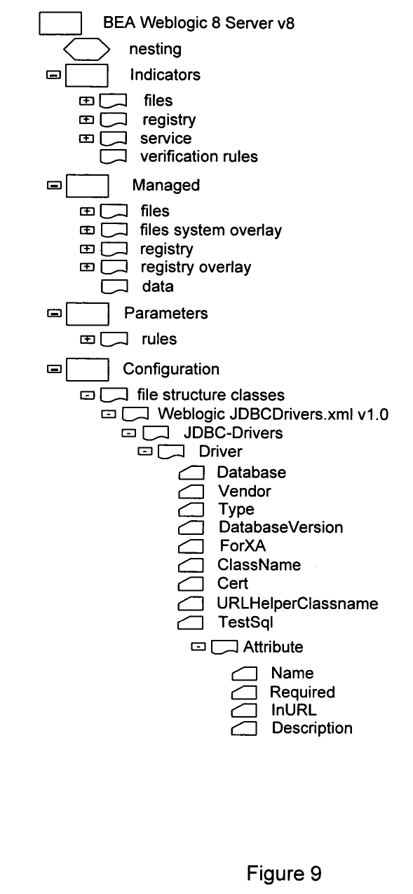

FIG. 9 is a generalized block diagram illustrating additional detail of an example component blueprint as illustrated in FIG. 8. As shown, the component blueprint provides additional detail on a possible embodiment. The additional detail provides information on the data structure of the structure class folder within the Configuration rule sets folder. Note, for illustration purposes, many other components of the component blueprint have been omitted.

Within the file structure class folder is a folder for Weblogic JDBCDrivers.xml files. Within that folder is a folder for JDBC-Drivers. Within the JDBC-Drivers folder is a Driver folder. Within the driver folder are multiple configuration parameters including a Database parameter, Vendor parameter, Type parameter, Database Version parameter, ForXA parameter, ClassName parameter, Cert parameter, URL HelperClassname parameter, and TestsSql parameterer. Also within the driver folder is an Attribute folder. Within the Attribute folder is a group of parameters. The parameters include Name parameter, a Required Parameter, an InURL parameter, and a Description parameter. This example shows the level of detail permitted in the present invention where rules for the drivers of a component may be organized to include rules and/or data on the attributes of the driver including the name of the driver, rules or data relating to requirements of the driver, and a description of the driver. Examples of parameter attributes are shown in Tables 1 and 2.

TABLE 1
Driver ClassName Parameter

| | |
|---|---|
| Name | ClassName |
| Description | Driver's Class Name |
| Category | Security, Performance |
| Filter | Time Variant |
| Weight | high |
| Data type | String |
| Interpret As | Java Class Name |

The ClassName structure class entry within the component blueprint provides meta data for interpretation of the parameter. The meta-data includes information on the context of the parameter, such as Interpret As, which aid in the use of the parameter, but do not actually add information to the parameter in the sense that the parameter, for use in BEA's Weblogic 8 Server v8, was intended by BEA to be interpreted as a Java Class Name. Other meta-data within the component blueprint includes enhancement meta-data which provide additional capabilities for managing the configuration of the BEA's Weblogic 8 Server v8. One example of the enhancement meta-data is the weight, which is used by the configuration management server to assign an importance to the parameter. This importance may not have come from the software vendor (in this case, BEA) and therefore enhances the configuration parameter by allowing for information not provided by BEA or contained in the parameter to be available to assist in configuration management.

Another example of the meta-data of a parameter from the component blueprint shown in FIG. 9 is given below in Table 2.

TABLE 2
Driver Database Parameter

| | |
|---|---|
| Name | Database |
| Description | Database Name |
| Category | Resources |
| Filter | Host Specific |
| Weight | high, medium, low |
| Data type | String |
| Interpret As | Database Name |
| Relationship | True |
| Key | |

As shown in Table 2, the Database structure class entry within the component blueprint provides meta-data to use and interpret the parameter called “Database” in the associated configuration file. The meta-data includes information similar to the ClassName Parameter described above in connection with Table 1, but also includes meta-data specifying that this parameter establishes a relationship between this component and an external entity (in this case a specific relational database).

As these examples show, the blueprint data model is sufficiently flexible to allow addition of enhancement meta-data to provide information on the relationship of the parameter to other information within the configuration database. In this manner the present embodiment allows for enhanced flexibility to mange configuration information, including presenting views, discovery of applications, components or hosts, discovery and/or collection of configuration data, comparison and correction and the application of stored configuration data to computer systems.

The present embodiment provides meta-data to aid in the interpretation of configuration data. Interpretation attributes may be assigned to any data element. These interpretation attributes may be used to parse the data elements, allowing the extraction of information contained within the data element. For example, a URL may contain a host name or IP address. Using the interpretation attribute, the configuration management server is able to parse the URL to extract the host name or IP address. Additional examples of interpretation attributes include, without limitation, email address, hostname or IP address, hostname and port, TCP port number, UDP port number, network protocol, network domain, filename or path, filename, directory name or path, directory name, registry value path, registry value name, registry key path, registry key name, JDBC URL, web services URL, database name, database table, version string, java class name, SNMP community string, SNMP object ID, LDAP path, LDAP entry, date, time of day, date and time, and description.

In the preferred embodiment the configuration data model is implemented as a combined relational-XML model. The values of attributes are, generally, stored within a relational database within the configuration database. The blueprints are implemented as XML, and are also stored within the configuration database.

As shown, the application blueprint is a meta-model of a distributed application containing the meta-data of the distributed application. In the preferred embodiment, the meta-data includes higher level relationship information specifying the components of the Application Blueprint.

### CONFIGURATION DATA DISCOVERY PROCESS

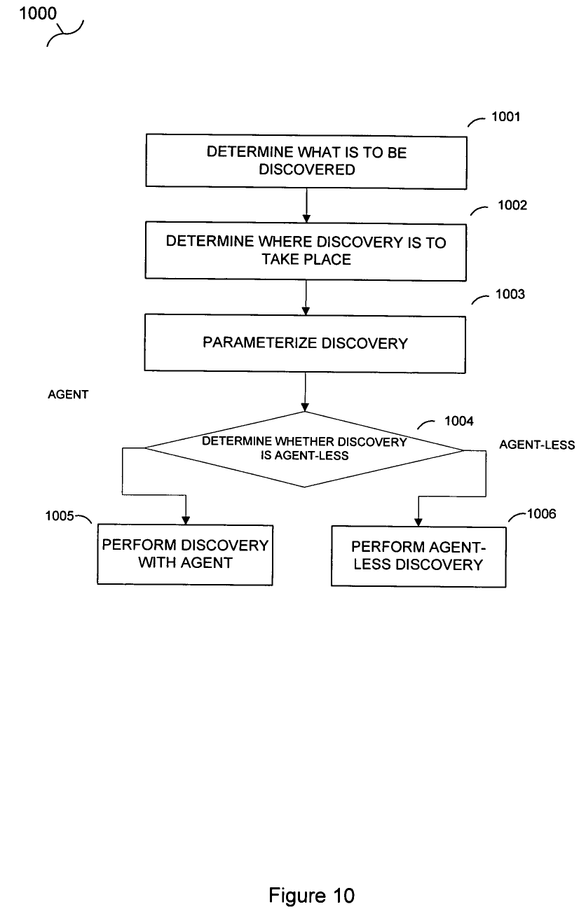

The application blueprint provides information which guides the discovery of installed software components on an application server or group of application servers. The present invention provides the ability to discover configuration data, and other information about a target computer, either through the use of an agent or without having an agent on the target computer. The process of discovering components, applications, hosts and configuration data is discussed in connection with FIGS. 10 through 13.

FIG. 10 is a general flow diagram of the process 1000 of discovering software components in a data center. (Unless otherwise noted, the term datacenter is used generally to refer to multiple computers which a connected through a communications network, and does not refer to the type of building or number of buildings the computers may reside in.)

At step 1001 the configuration management server determines what types of software are to be discovered. In the presently preferred embodiment, the discovery process seeks to identify applications, hosts or components through the application of blueprints. While alternate embodiments could seek to discover other combinations of software, hardware or data, the present example will discuss discovery in the context of applications, hosts and components.

At step 1002 the configuration management server determines where the discovery is to take place. The present embodiment allows for the discovery process to be narrowed to a single target computer, or expanded to cover a list of target computers identified by an attribute, such as the target host name or target host IP address. The present embodiment also provides the ability to specify an open ended set, or group, of target computers. This may be performed by specifying criteria that a target needs to satisfy for inclusion in the target discovery group. As an example, the criteria may be all target servers having an IP address within a specified range (say, on a particular subnet). Other examples, without limitation, are target servers with a specified identifier in their host name, by type of host server, or any other attribute which may be included in a host target host group rule.

At step 1003 the configuration management server parameterizes the discovery. Thus, the parameterization may include exclusions (for example, certain drives or directories of the target server(s), symbolic links, mount points, etc.), as well as depth limits (for example, how far on a directory tree to look before terminating), time limits, limits on the number of targets include in the discovery within a time period, and/or resource consumption limits (amount of RAM to consume or percentage of CPU cycles to consume). In this manner the present invention is able to throttle the discovery, or divide the discovery into segments, to prevent excessive negative impacts on the performance of the target servers.

At step 1004 the system determines whether to perform the discovery using and agent or by using an agent-less process. In the preferred embodiment, the determination of whether to perform the discovery by agent or agent-less process may be specified. Unless specified, the preferred embodiment defaults to using an agent in the event an agent is installed on the target. If an agent is not installed on the target, the configuration management server may proceed with an agent-less discovery, or may declare a fault if such a rule is put in place. In the presently preferred embodiment, the configuration management server has the ability to determine whether an agent is installed on a given target server (either by comparing to a list of agents and the target servers they are installed on, or by querying the target server to determine whether an agent is installed on the target server).

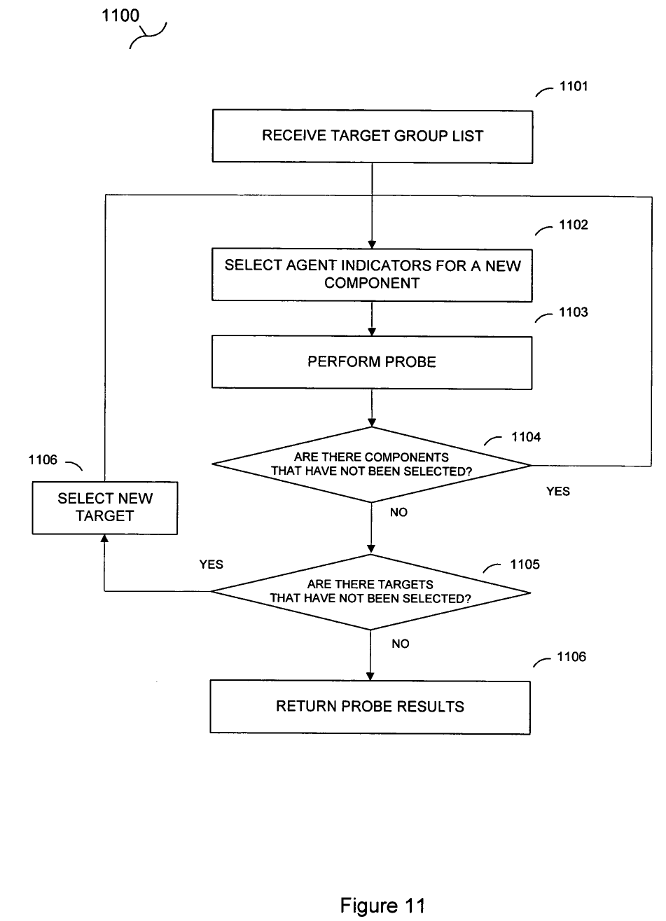

If at step 1004 the configuration management server determines the discovery is to be performed with an agent, the system proceeds to step 1005. At step 1005 the configuration management server proceeds to step 1 101 of process 1 100 described below in connection with FIG. 11.

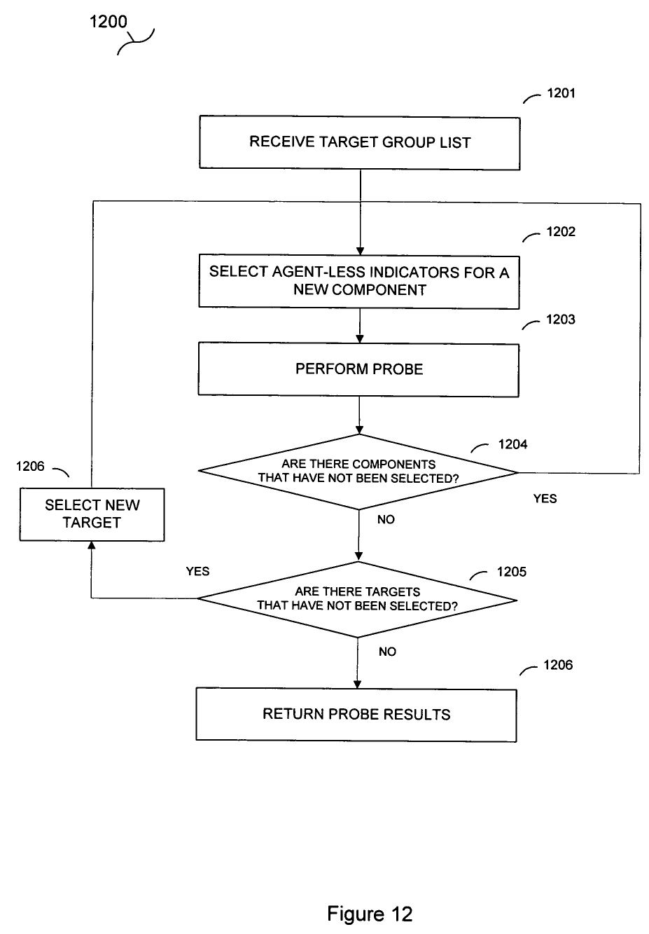

If at step 1004 the configuration management server determines the discovery is to be performed without an agent, the system proceeds to step 1006. At step 1006 the configuration management server proceeds to step 1201 of process 1200 described below in connection with FIG. 12.

While the example embodiment of process 1000 includes the ability to perform both agent and agent-less discovery, alternate embodiments could rely solely on either form of discovery.

FIG. 11 is a general flow diagram of the process 1100 of discovery using an agent installed on the target server. At step 1101 the configuration management server receives the target group list from process 1000 described above.

At step 1102 the configuration management server selects the agent indicators for a component according to the component blueprints. As described above, the component indicators specify attributes of a component the configuration management server is seeking to find to make a determination as to whether the associated component exists. In the presently preferred embodiment, both agent and agent-less indicators exist in the component blueprint. With an agent on a target server additional attributes may be checked (if the agent has sufficient privileges, as the example embodiment assumes it does). Examples of attributes that an agent may check for, which are often not discoverable without an agent, include registry variables, certain files, and possibly other attributes. Accordingly, agent indicators may include attributes such as those given as examples which may be discovered by an agent with the proper permission, but which would not ordinarily be discoverable without an agent on the target server.

At step 1103 the configuration management server performs the probe by passing indicators to the agent and receives and stores the results of the probe. The configuration management server sends the agent indicators list to the agent on the target, which performs the probe, and reports the results of the probe to the configuration management server. As an example, if an agent indicator specified a given registry variable, the agent would look in the registry of the target server for the specified registry variable. If it found the specified registry variable, it would return this result to the configuration management server. If the agent was unable to locate the specified registry variable in the registry of the target server, the agent would report the failure of the probe to the configuration management server, which would store the result for the target server.

At step 1104 the configuration management server determines whether there are additional components which have not been included in the probe of the target. If there are additional components which have not been probed, the configuration management server returns to step 1 102 where the agent indicators for a component that has not been probed on the current target is selected. The preferred embodied allows steps 1 102, 1103 and 1104 to be combined into a single step, where-in all indicators for all selected components are combined into a composite indicator list. This composite indicator list is sent to the agent which can perform search for all components simultaneously.

If at step 1104 it is determined that there are no additional components that have not been included in the probe of the present target, the configuration management server proceeds to step 1105.

At step 1105 the configuration management server determines whether there are targets that have not been included in the agent probe of the group of target servers. If at step 1105 the configuration management server determines there are target servers of the group of target server that have not been part of the probe, the system proceeds to step 1106 to select a target server from the group which has not been probed.

After step 1106, the configuration management server returns to step 1102 where it selects agent indicators for a component to include in a probe of the selected target server.

If at step 1105 it is determined that there are no additional target servers from the group that have not been included in the probe, the configuration management server proceeds to step 1107.

At step 1107 the configuration management server returns the results of the probe as a probe list to step 1301 of process 1300 described below.

FIG. 12 is a general flow diagram of the process 1200 of agent-less discovery of a target server. At step 1201 the configuration management server receives the target group list from process 1000 described above.

At step 1202 the configuration management server selects the agent-less indicators for a component according to the component blueprint.

At step 1203 the configuration management server performs the probe using the agent-less indicators and receives and stores the results of the probe.

At step 1204 the configuration management server determines whether there are additional components which have not been included in the probe of the target. If there are additional components which have not been probed, the configuration management server returns to step 1202 where an agent-less indicators that has not been probed on the current target is selected. Examples of agent-less indicators include, without limitation, information relating to LDAP, JMX, SNMP, data in database, services, socket probe or IP address, or remote executables.

If at step 1204 it is determined that there are no additional components that have not been included in the probe of the present target, the configuration management server proceeds to step 1205.

At step 1205 the configuration management server determines whether there are targets that have not been included in the agent probe of the group of target servers. If at step 1205 the configuration management server determines there are target servers of the group of target server that have not been part of the probe, the system proceeds to step 1206 to select a target server from the group which has not been probed.

After step 1206, the configuration management server returns to step 1202 where it selects agent-less indicators for a component to include in a probe of the selected target server.

If at step 1205 it is determined that there are no additional target servers from the group that have not been included in the probe, the configuration management server proceeds to step 1206.

At step 1206 the configuration management server returns the results of the probe as a probe list to step 1301 of process 1300 described below.

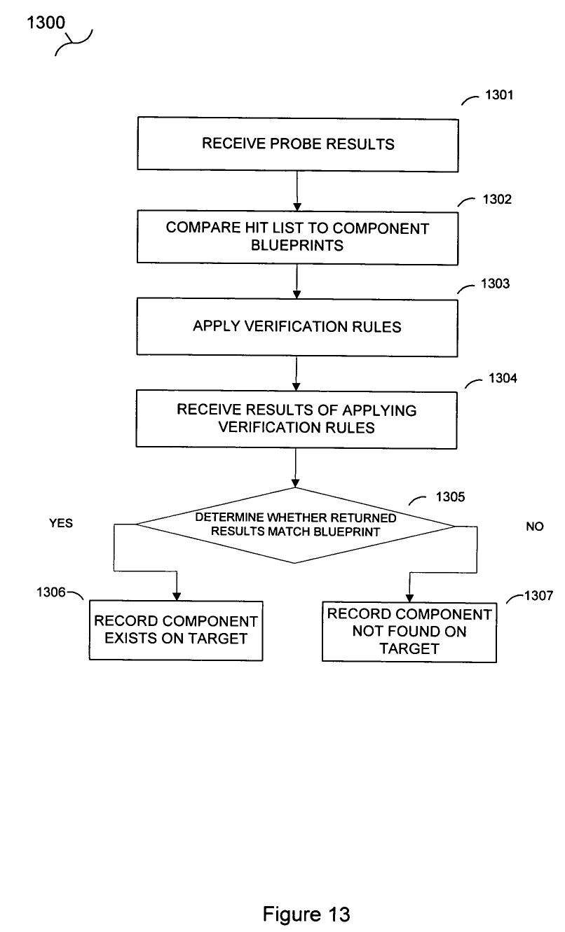

FIG. 13 is a general flow diagram of the process 1300 of discovery of a target server using the returned probe list. At step 1301 the configuration management server receives the results of the probe from either process 1100 or process 1200, described above. At step 1302 the configuration management server compares the received results of the probe to the component blueprint to find a match. More particularly, in the presently preferred embodiment, the configuration management server compares the hit list, or the list of elements or attributes which match the indicators (agent or agent-less) that were found on one of the target servers. The configuration management server prepares a list of possible discovered components.

At step 1303 the configuration management server generates a list of verification rules based upon the list of possible discovered components. The list of verification rules test whether the possible discovered components actually exist among the group of target servers. A verification rule may be in any form, but in the preferred embodiment the verification rule runs an executable, or may change the value of a registry variable.

At step 1304 the configuration management server receives the results of applying the verification rules. From running an executable, a result is received. For example, the execution rule may specify sending a given command to a particular target server, or specify sending a particular value or message to a given address. The results, if there are any, are received and stored. If no result is received in response to running the executable this null result is also noted.

At step 1305 the configuration management server compares the received results to the component blueprint to determine if the component is actually installed on the target computer. If the component corresponding to the component blueprint is installed and running on the group of target servers (at least one of the target servers) the associated component will, in response to the executable of the verification rule, return the expected result stored in the component blueprint.

If at step 1305 the configuration management server receives the expected result, the configuration management server proceeds to step 1306 where the component database is updated to reflect the discovery of the associated component. Additional details of the component discovered during the probe, such as the name and address of the target server(s) the associated component is installed on, are also stored in the configuration database in the preferred embodiment.

### RULE SETS

The presently preferred embodiment provides for policy enforcement through rules. The rules may be grouped into rule sets to implement a policy. For example, to implement a security policy a group of rules may be grouped together and run by the rules engine of the configuration management server.

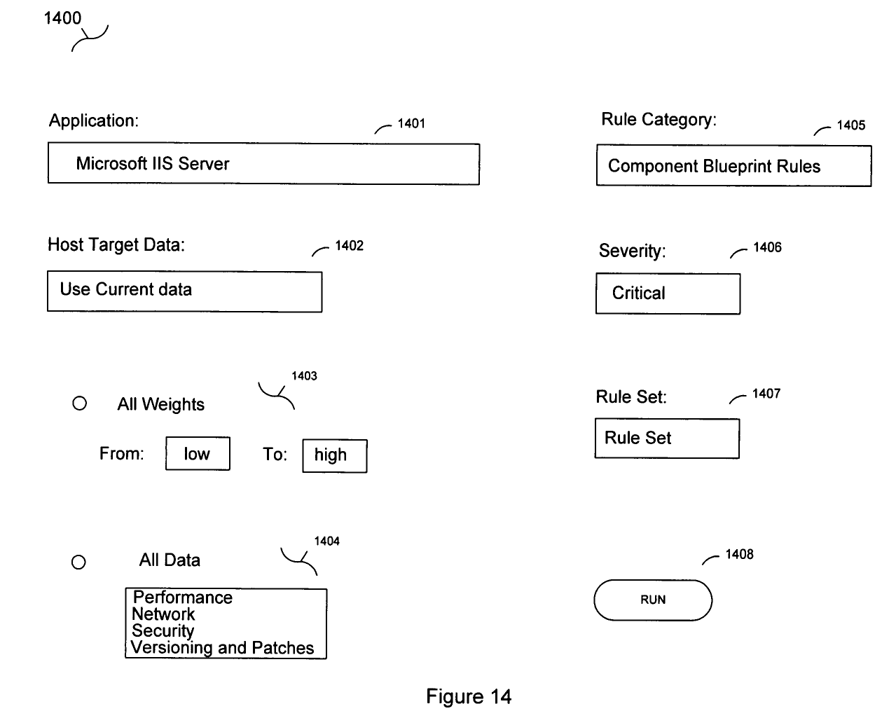

FIG. 14 is a generalized block diagram of a screen 1400 to select and run rules and rule sets. A target is selected in host target entry field 1401. Host target data is selected in host target entry field 1402. The selected host target data may be the configuration data of a given target host, or may be another data set. For example, compliance with rules may be performed by running a rule set against saved versions of configuration data. In systems which take regular snapshots of configuration data, as the present system may be used, this provides for both checking of historical compliance and troubleshooting of problems in that may be impacted by miss-configuration of computer systems.

Weights of data may be selected using the weights selector 1404. The weights selector allows for selection of a given weight, a range of weights, or all weights. Similarly, configuration data may be selected using the configuration data selector 1404. The configuration data selector lists the types of data that may be selected, such as network data, performance data, or data relating to security. The selector also allows all available data for the host target to be selected.

The rule category entry field 1405 provides for the category of rules to be entered or selected. An example of a rule category is component blueprint rules. Other example rule set categories include, without limitation, host blueprint rules, application blueprint rules, application and component blueprint rules, etc. The severity of rules may also be selected by entering/selecting a severity in the rule severity entry field 1406. By choosing a given severity, such as critical, the system is able to exclude, or filter, rules according to severity.

A rule set selector 1407 allows for a given rule set to be selected, and may allow for a new rule set to be entered or otherwise specified. An execution/run button 1408 allows the selected or entered rule or rule set to be run.

The entry fields depicted in FIG. 14 may be implemented as entry fields, drop down menu, or both (as in the preferred embodiment). However, alternate forms of selecting or entering the desired information may be used without departing from the scope of the present invention.

### RULE ENFORCEMENT PROCESS

The presently preferred embodiment provides for the enforcement of rules against the known attributes of servers managed by the configuration management server. In one embodiment, a rule can be though of as a constraint on an attribute value. Rules may be applied to any of the attributes of a server. For example, some rules may apply to values, such as an IP address. Other rules may apply to other attributes, such as file owners or file size within a component.

The presently preferred embodiment allows rules to be defined using variable substitution, thus extending the ability of a rule to enforce a policy to multiple attributes of an application, host or component. Variable substitution allows the value of any element or element attribute in the configuration database to be used as the constraint value in a rule. For example the value of a configuration parameter in one software component A, produced by Vendor A may have a relationship to another configuration in a different component B produced by Vendor B. When components A and B are used together, the value of the configuration in A may be constrained to be greater, equal or less than (for example) the related parameter in B according to their functional dependency.

The presently preferred embodiment allows rules to have attributes. For example, a rule may have a severity attribute which indicates the importance of the rule. One example of a severity attribute is to assign rules a severity attribute value of information, warning, error and critical. If a rule is violated the configuration management server checks the severity attribute and takes action based upon the severity attribute value for the violated rule. Also, the severity attribute value may be used to filter rules. For example, a given process may be filtered by the configuration management server according to rule severity. An example would be to apply security policy rules to a group of servers, and filter according to severity value of critical, thus only applying those rules that are essential to maintain security, while rules of lesser severity value will be ignored.

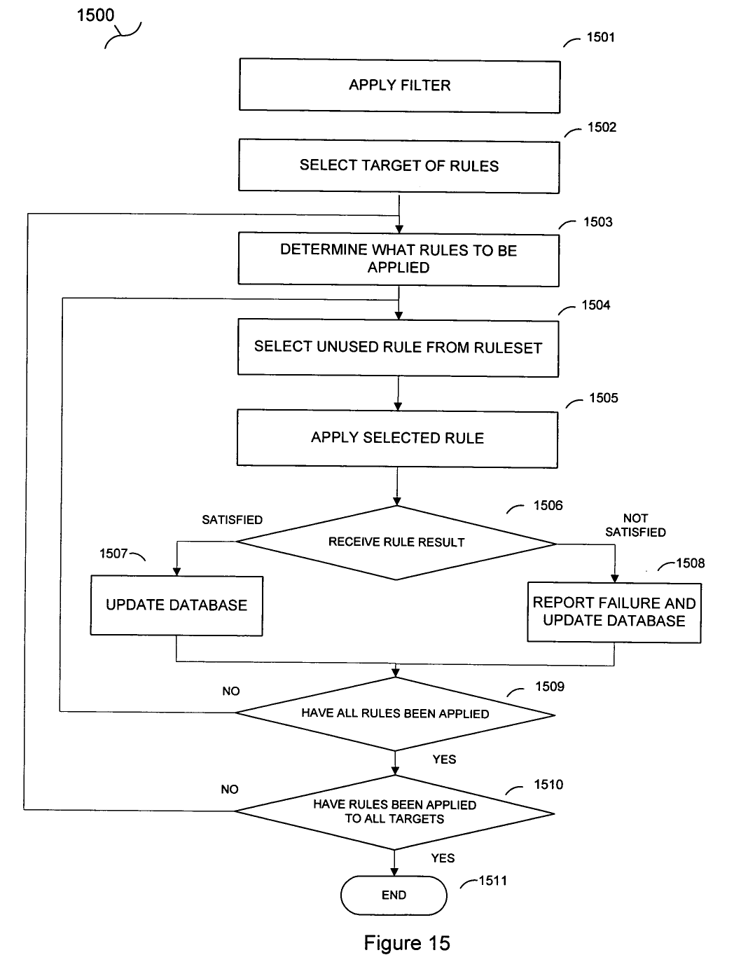

The process 1500 of applying and enforcing rules is illustrated in FIG. 15. At step 1501 the configuration management server applies filters to the data set. The filters may limit the types of files considered, the type of hosts included, or may limit based upon any other attribute.

At step 1502 the configuration management server selects the data to apply the rule set against. The rules engine can apply a rule set against any data set it has access to. For example, to enforce a security policy, a rule set may be selected for application against a group of host servers. For illustration purposes, the discussion will refer to applying the rules to a host server, even though the rules may be applied to any data set, whether or not obtained directly from a host server or whether obtained from a database.

The group of host servers may be selected by a predefined list. The present embodiment allows rules application and enforcement process to be narrowed to a single host computer, or expanded to cover a list of host computers identified by an attribute, such as the target host name or target host IP address. The present embodiment also provides the ability to specify an open ended set, or group, of target host computers. This may be performed by specifying criteria that a target needs to satisfy for inclusion in the group of host servers. As an example, the criteria may be all target servers having an IP address within a specified range (say, on a particular subnet). Other examples, without limitation, are target host servers with a specified identifier in their host name, by type of host server, or any other attribute which may be included in a host target host group rule.

At step 1503 the configuration management server determines what rules to be run. Rules may be chosen, for example, according to the form defined in FIG. 14.

At step 1504 the configuration management server selects a rule from the rule set that has not already been applied by the configuration management server in this instance (a given rule may have been applied in a different rule set, against a different host, or against different components or applications, which would not be the same instance in the preferred embodiment).

At step 1505 the configuration management server applies the selected rule against the host server selected for application of the rule set. Typically, the selected application is a host server, and may be one of a group of host server.

At step 1506 the configuration management server receives the results of the application of the rule to the selected host server and determines whether the rule has been satisfied. Rules, in the presently preferred embodiment, return Boolean values. An example of a Boolean rule is that a given TCP port on a server must be closed to receive outside communication. As the rules engine applies the rule, either the TCP port is closed or it is open. If it is closed, then in this example, it satisfies the rule and has a Boolean value of true. If the TCP port is open, then the rule has been violated and the Boolean value is false.

If at step 1506 the configuration management server determines the rule has been satisfied, the configuration management server proceeds to step 1507 and records the satisfaction of the rule in the configuration database.

If at step 1506 the configuration management server determines the rule has not been satisfied, the configuration management server proceeds to step 1508 and records the failure of the rule in the configuration database. Additionally, the configuration management server may send an alert or take other action based upon the failure of the rule.

From both step 1507 and 1508 the configuration management server proceeds to step 1509 where it determines whether the there are additional rules to apply to the host server. If the configuration management server determines that not all the rules of the rule set have been applied, the configuration management server proceeds to step 1504 to select a rule which has not yet been applied in this instance. If the configuration management server determines all the rules of the rule set have been applied, the configuration management server proceeds to step 1510.

At step 1510 the configuration management server determines whether the rule set has been applied to all the host servers in the host group. If the configuration management server determines there are host servers that the rule set has not been applied, the configuration management server proceeds to step 1503 to select a host server which the rule set has not been applied. If the configuration management server determines that the rule set has been applied to all the host servers of the host group, the configuration management server proceeds to step 1511 where process 1500 terminates.

### COMPARISON PROCESS

The application blueprint provides information which guides the process of comparison of two (or more) target servers. The present invention allows for comparisons across time or across space. An example of a comparison across time is the comparison of a server at a given time and the same server at a later time, as may be done when comparing before and after states when a change has been made to a server. An example of a comparison across space is comparing a staging server to a production server, as may be done to compare the configuration settings of the production environment to determine what configuration settings of the production server differ from the configuration settings of the staging server.

In the presently preferred embodiment, the comparison is logically arranged in a hierarchy of comparing applications, hosts and components. As there may be multiple hosts in a given application, or multiple components in a given host, the possible comparisons are illustrated in Table 3, which specifies whether a given element is a one to one or one to many comparison.

TABLE 3

| | Application | Host | Component |
|---|---|---|---|
| Application | 1 to 1 | | |
| Host | | 1 to 1/1 to many | |
| Component | | | 1 to 1/1 to many |

As shown in Table 3, applications, in the presently preferred embodiment, are compared on a one to one basis. For example, comparing an application such as an email application to either an unknown application, or to another email application, are both one to one comparisons. If there is more than one application to be compared, for example, to a reference application, these comparisons may be performed separately.

As a given application may have several host types, the comparison of a host may involve comparison to one host, or the comparison of one to many hosts, as shown in Table 3 This is illustrated by the example of comparing two applications, the first application having one host, and the second application having five hosts, The comparison then involves the comparison of the one host of the first application to the five hosts of the second application.

Similarly, Table 3 also illustrates that components may be compared as either one to one, or one to many, as a given host (or, by extension, a given application) may have one component or multiple components.

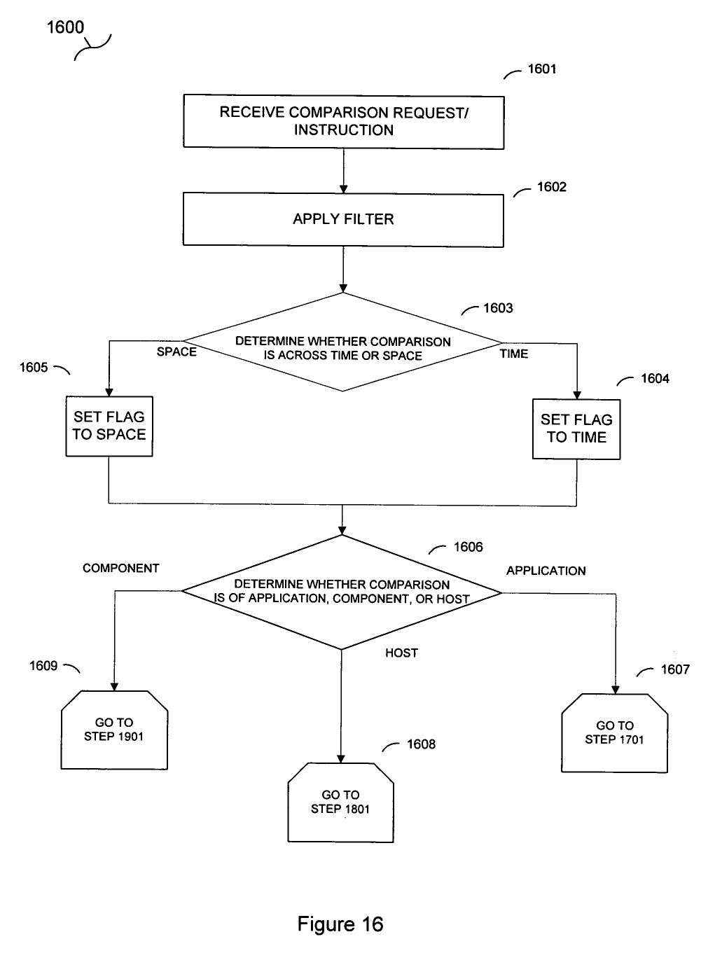

The process of comparing elements is illustrated by example in FIGS. 16 through 18.

FIG. 16 is a generalized flow diagram illustrating the process 1600 of comparing configuration data. At step 1601 the configuration management server receives a request or instruction to perform a comparison. This request identifies that applications, host and components to be compared and in which configuration (one-to-one or one-to-many). At step 1602 the configuration management server applies filters that may have been selected, or any filters that may have set up (for example, a filter on the weight or categorization of elements).

At step 1603 the configuration management server determines whether the comparison is to be performed across time or across space. An example of a comparison across time would be to compare the current configuration of a host server to a prior configuration of the same host server. An example of a comparison across space would be to compare the configuration of a staging host server to the configuration of a production host server.

If at step 1603 the configuration management server determines the comparison is to be across time, the configuration management server proceeds to step 1604 where a comparison flag is set to indicate the comparison is across time.

If at step 1603 the configuration management server determines the comparison is to be across space, the configuration management server proceeds to step 1605 where a comparison flag is set to indicate the comparison is across space.

After step 1604 or 1605 the configuration management server proceeds to step 1606.

At step 1606 the configuration management server determines whether the comparison is to be made between applications, between hosts, or between components.

If at step 1606 the configuration management server determines the comparison is to be made between applications, the configuration management server proceeds to step 1607. At step 1607 the configuration management server forwards to step 1701 of process 1700 described below.

If at step 1606 the configuration management server determines the comparison is to be made between hosts, the configuration management server proceeds to step 1608. At step 1608 the configuration management server forwards to step 1801 of process 1800 described below.

If at step 1606 the configuration management server determines the comparison is to be made between components, the configuration management server proceeds to step 1609. At step 1609 the configuration management server forwards to step 1901 of process 1900 described below.

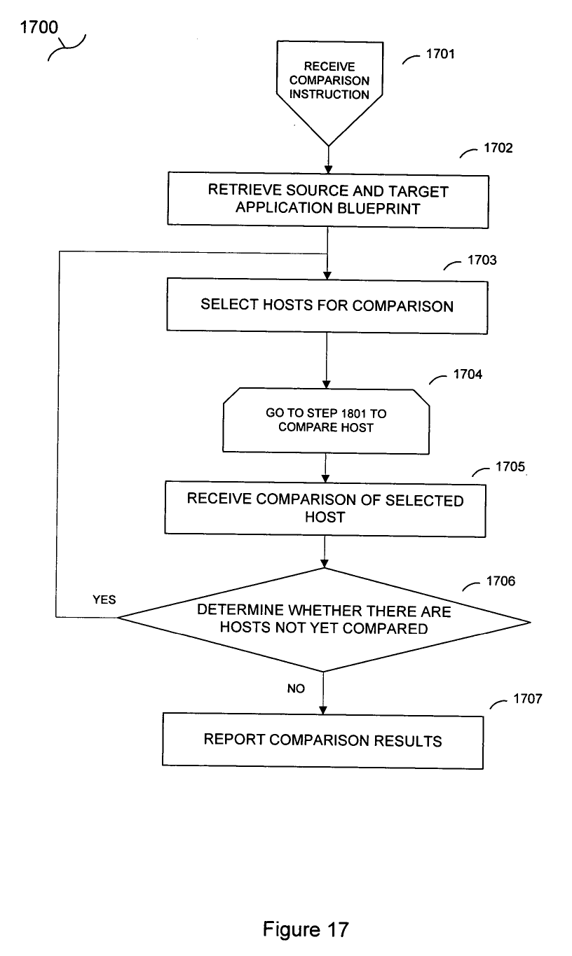

FIG. 17 is a generalized flow diagram illustrating the process 1700 of comparing configuration data between applications. At step 1701 the configuration management server receives instructions to compare applications. As discussed above in connection with Table 4, the comparison between applications is only done on a one to one basis in the presently preferred embodiment. The compare applications instruction specifies the applications to compare, or provides an instruction on where to retrieve information on the applications to compare.

At step 1702 the configuration management server retrieves managed data for the source and target applications to be compared. At step 1703 the configuration management server selects a source host and a target host for comparison. As described above, applications include at least one host. The configuration management server selects a host form the source application and a host from the target application. At step 1704 these selected hosts are forwarded to step 1801 of process 1800 for comparison.

At step 1705 the configuration management server receives the results of the comparison of the source and target hosts by process 1800.

At step 1706 the configuration management server determines whether there are either target hosts or source hosts which have not been compared yet. If there are source or target hosts which have not yet been compared, the configuration management server returns to step 1703 where it selects a source host and a target host for comparison, where at least one of the two selected hosts has not already been compared.

If at step 1706 the configuration management server determines that all of the source and target hosts specified in the source and target applications blueprints retrieved at step 1702 have been compared, the configuration management server proceeds to step 1707. At step 1707 the configuration management server reports the results of the comparison of the source and target application. The reporting may be to a database for storage and later retrieval, to an administrator, or to another system of module of the configuration management server for further analysis and/or reporting.

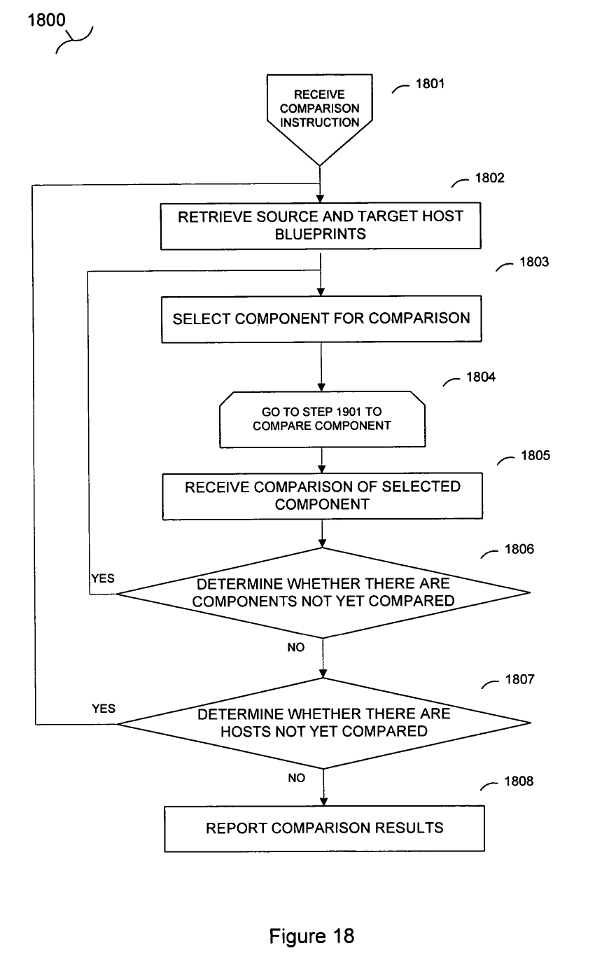

FIG. 18 is a generalized flow diagram illustrating the process 1800 of comparing configuration data between hosts, according to one embodiment of the invention. At step 1801 the configuration management server receives an instruction to compare source and target hosts. The instruction may be received from another comparison process, such as process 1700, or from an administrator. At step 1802 the configuration management server retrieves the source host data and the target host data. At step 1803 the configuration management server selects a source component and target component for comparison based upon the source host and target host retrieved at step 1802. As described above, hosts include at least one component. The configuration management server selects a component form the source host blueprint and a component from the target host. At step 1804 these selected components are forwarded to step 1901 of process 1900 for comparison.

At step 1805 the configuration management server receives the results of the comparison of the source and target components by process 1900.

At step 1806 the configuration management server determines whether there are either target components or source components which have not been compared yet. If there are source or target components which have not yet been compared, the configuration management server returns to step 1803 where it selects a source components and a target components for comparison, where at least one of the two selected components has not already been compared.

If at step 1806 the configuration management server determines that all of the source and target components specified in the source and target host retrieved at step 1802 have been compared, the configuration management server proceeds to step 1807. At step 1807 the configuration management server reports the results of the comparison of the source and target host blueprints. The reporting may be to a database for storage and later retrieval, to another process such as process 1700, to an administrator, or to another system of module of the configuration management server for further analysis and/or reporting.

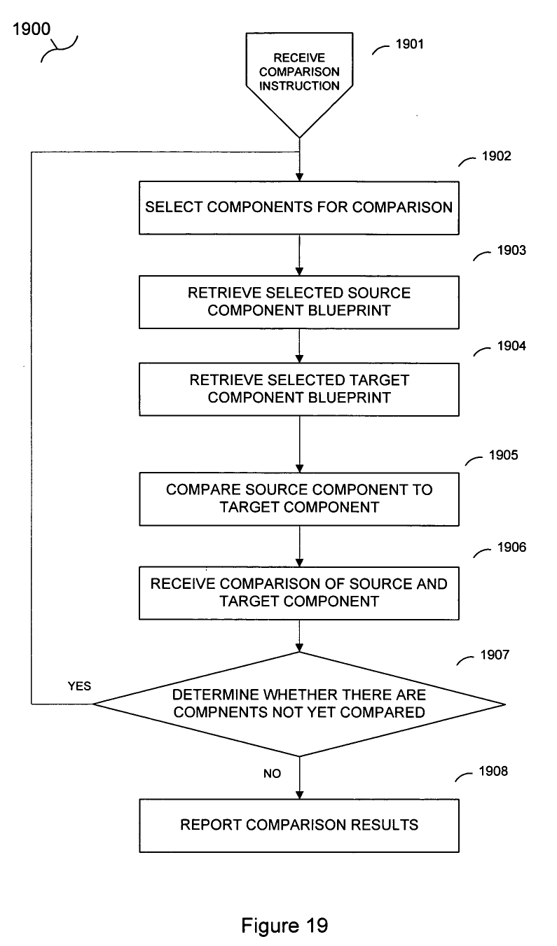

FIG. 19 is a generalized flow diagram illustrating the process of comparing configuration data between components, according to one embodiment of the invention. At step 1901 the configuration management server receives an instruction to compare source and target component. The instruction may be received from another comparison process, such as process 1800, or from an administrator. At step 1904 the configuration management server selects a source component and target component for comparison. If the component comparison instruction received at step 1901 included only one source component and one target component, then the selection at step 1902 uses these received source and target components to make the selection. If more than one of either source or target components were received at step 1901 the configuration management server selects one source component and one target component for comparison.

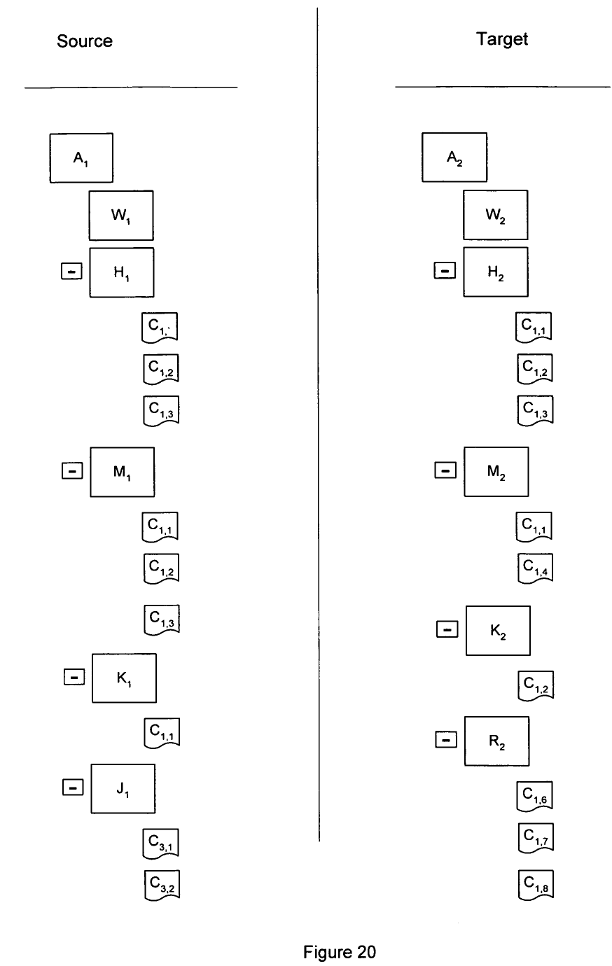

At step 1903 the configuration management server retrieves the source component blueprint. At step 1904 the configuration management server retrieves the target component blueprint. As described above, component blueprints include elements such as folders, files and parameters. The configuration management server selects an element from the source host blueprint and an element, such as a file or parameter, registry variables, data, configuration files, configuration executables, or other elements of the source or large, from the target host blueprint. At step 1905 these selected elements of the component blueprints are compared. The comparison may vary depending upon the type of element being compared. For example, registry elements may be compared differently than configuration executable elements. Examples of other elements include files and directories, managed data, configuration data, and configuration file. During the comparison of elements the configuration management server refers to the comparison flag to determine whether the comparison is across space or across time. The configuration management server uses the comparison flag to determine what elements, if any, should be ignored. For example, certain attributes such as host name will typically be different if the comparison is across space, as two different hosts usually are given different host names. This, the configuration management server will ignore changes which it expects to be different in a comparison across space. Similarly, a comparison across time will naturally have certain attributes that are expected to be different, for example, the size of logging files. During the comparison the configuration management server may look at the size of a file, permission attributes of a file or parameter, creation time, modification time, etc. If the compared elements match at step 1905 the configuration management server enters a value to indicate a match. If the compared elements do not match at step 1905 the configuration management server enters a value to indicate the compared elements do not match. As two components may have different elements, as illustrated by the source and target blueprints shown in FIG. 20 which are alike, but not identical, the configuration management server

At step 1906 the configuration management server receives the results of the comparison of the source and target components by process 1900.

At step 1906 the configuration management server determines whether there are either target components or source components which have not been compared yet. If there are source or target components which have not yet been compared, the configuration management server returns to step 1903 where it selects a source components and a target components for comparison, where at least one of the two selected components has not already been compared.

If at step 1906 the configuration management server determines that all of the source and target components specified in the source and target host blueprints retrieved at step 1902 have been compared, the configuration management server proceeds to step 1907. At step 1907 the configuration management server reports the results of the comparison of the source and target host blueprints. The reporting may be to a database for storage and later retrieval, to another process such as process 1700, to an administrator, or to another system of module of the configuration management server for further analysis and/or reporting.

FIG. 20 is a generalized block diagram illustrating the comparison of source and target blueprints. As can be seen from the example source and target blueprints, the blueprints are similar in overall structure and many folders and files are the same, as indicated by the letter and number identifying each element of the blueprint. For example, at the highest level of the blueprint are folders A₁ and A₂. At the next level down the files in the folders M₁ of the source and M₂ or the target do not have the same number of files. Specifically, the source has three files, C_{1,1}, C_{1,2,} and C_{1,3}. By contrast, the target has files C_{1,1} and C_{1,4}. Thus, a comparison the source and target blueprints would note both the difference in the number of files in the folder M, as well as the lack of a direct match for files C_{1,2}, C_{1,3} and C_{1,4}.

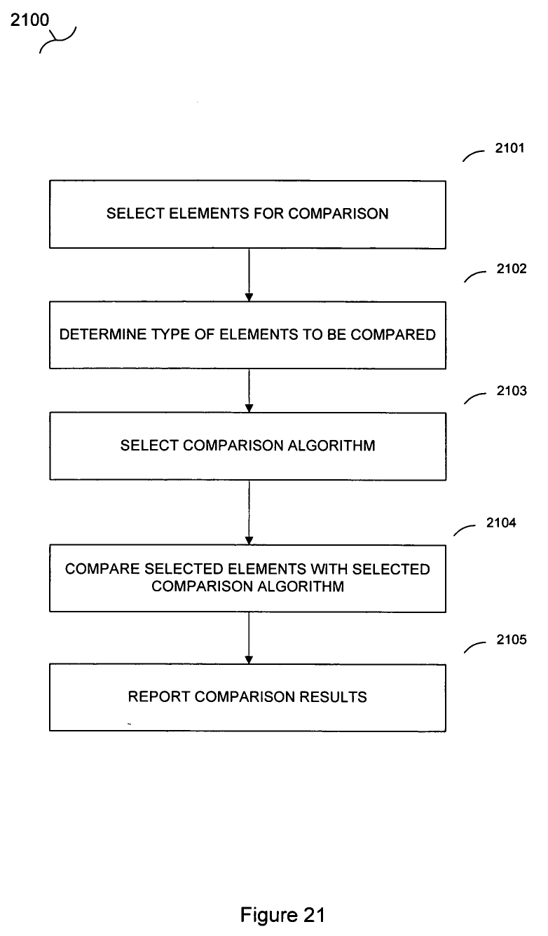

Comparison of the source and target includes the comparison of configuration elements on an element by element basis. Comparison between two blueprints involves an element by element comparison. FIG. 21 is a generalized block diagram illustrating the process 2100 of element comparison. At step 2101 the elements to be compared are identified or received (for example, received from another process). At step 2102 the system determines what type of elements are to be compared. Configuration elements may be in the form of registry variables, managed data (such as database and meta data, tables, indicies, stored procedures. etc.), files or directories, configuration data (typically data stored in the rows and columns of a database such as a configuration database), configuration files (which typically have a structure which can be parsed), or configuration executables (typically data gathered from running executables, SNMP data, JMX, LDAP, etc.).

The comparison processes allow the data model to be applied to data to perform comparisons. One example is the application of an overlay, such as a structure class overlay, and apply the overlay to an instance of configuration elements. In such an application, the comparison of configuration elements involves the element by element of the “trees” of the overlay and instance. In such an application, the blueprints of the configuration data model provide rules to resolve ambiguities. Examples of the types of ambiguity resolving rules include matching decedents or matching named children.

In the presently preferred embodiment, comparison of each of these involves a different comparison algorithm. For example, comparing two directories would involve a different comparison algorithm than comparison of two sets of configuration data. The system selects the appropriate comparison algorithm at step 2103. At step 2104 the comparison is performed according to the selected comparison algorithm. At step 2105 the system outputs the results of the comparison (the output may be to a file, database, or to any other computer, network or I/O device). The output may determine that the compared elements are the same, that they are different, that one of the elements is missing (for example, when a given file exists in one directory but not in another), or added.

The invention has been described with reference to particular embodiments. However, it will be readily apparent to those skilled in the art that it is possible to embody the invention in specific forms other than those of the preferred embodiments described above. This may be done without departing from the spirit of the invention.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

We claim:

1. A method of performing discovery of a software component, comprising:
selecting agent-less indicators for a software component:
probing at least one target computer according to the selected agent-less indicators;
receiving the results of the probe according to the selected agent-less indicators;
comparing the results of the probe according to the selected agent-less indicators at least one component blueprint to determine if there is one or more software components that match the results of the probe;
in the event the determination is made that one or more software components match the results of the probe, selecting at least one agent-less verification rule, the selected one or more verification rules corresponding to the one or more software components that match the results of the probe;
applying the at least one or more selected verification rules;
receiving the results of the application of the agent-less verification rules; and
comparing the results of the application of the agent-less verification rules to at least one expected result of the agent verification rules to verify the existence of a software component corresponding to the selected agent-less verification rules.

2. The method of creating a rule set of claim 1, wherein the at least one expected result of the agent verification rules is retrieved from the component blueprint.

3. The method of creating a rule set of claim 1, wherein at least one of the selected agent-less verification rules specifies running an executable.

4. The method of detecting a software component of claim 1, further comprising:
receiving a list of target computers to be included in the discovery of the software application;
determine what software application is to be discovered;
retrieve a component blueprint associated with the software application determined for discovery; and
retrieving the selected agent-less indicators for a software component from said retrieved component blueprint.

5. A method of performing discovery of a software component, comprising:
determining whether the discovery is by an agent-less process or a process using an agent;
in the event the determination is made that the discovery is by an agent-less process, selecting agent-less indicators for a software component;
probing at least one target computer according to the selected agent-less indicators;
receiving the results of the probe according to the selected agent-less indicators;
comparing the results of the probe according to the selected agent-less indicators at least one component blueprint to determine if there is one or more software components that match the results of the probe;
in the event the determination is made that one or more software components match the results of the probe, selecting at least one agent-less verification rule, the selected one or more verification rules corresponding to the one or more software components that match the results of the probe;
applying the at least one or more selected verification rules;
receiving the results of the application of the agent-less verification rules; and
comparing the results of the application of the agent-less verification rules to at least one expected result of the agent verification rules to verify the existence of a software component corresponding to the selected agent-less verification rules.

6. The method of detecting a software component of claim 5, further comprising:
receiving a list of target computers to be included in the discovery of the software application;
determine what software application is to be discovered;
retrieve a component blueprint associated with the software application determined for discovery; and
retrieving the selected agent-less indicators for a software component from said retrieved component blueprint.

7. The method of detecting a software component of claim 6, wherein the discovery rules include at least one nesting rule, said nesting rule specifying the relationship between at least two software components.

8. The method of detecting a software component of claim 5, further comprising:
setting at least one discovery parameter specifying a limitation on the discovery process.

9. The method of detecting a software component of claim 5, further comprising:
in the event neither agent or agent-less discovery is specified for the discovery process, selecting agent-less indicators for a software component.
